(19) United States
(12) Patent Application Publication
(10) Pub. No.: US 2024/0158269 A1
(43) Pub. Date: May 16, 2024

(54) Anaerobic Migrating Blanket Reactor and Methods of Using the Same

(71) Applicant: Bennett Environmental, LLC, Visalia, CA (US)

(72) Inventors: Jelte Lanting, Williamstown, NJ (US); Edward John Schaap, Visalia, CA (US); Rhett Bergman, Visalia, CA (US)

(21) Appl. No.: 18/509,198

(22) Filed: Nov. 14, 2023

Related U.S. Application Data
(60) Provisional application No. 63/509,490, filed on Jun. 21, 2023.
(60) Provisional application No. 63/425,305, filed on Nov. 14, 2022.

(51) Int. Cl. C02F 3/28

(52) U.S. Cl. CPC C02F 3/2846; C02F 3/286; C02F 2103/20; C02F 2209/08

(57) ABSTRACT

A method of treating wastewater comprising soluble chemical oxygen demand and particulate chemical oxygen demand is described as well as an apparatus therefor that is an anaerobic migrating blanket reactor apparatus (AMBR). The method provides an AMBR structure with wastewater influent inlet(s), biogas outlet(s) and effluent outlet(s). The AMBR structure defines at least three reaction chambers that are configured to permit bidirectional, generally transverse flow, in a first direction and a second direction, through the at least three reaction chambers. Wastewater influent enters the first reactor chamber and flows in a first direction through the first reactor chamber, the second reactor chamber, the third reactor chamber and through an effluent outlet for a first period of time. Wastewater influent enters the second reactor chamber and flows in the first direction through the second reactor, the third reactor and an effluent outlet for a second period of time. Wastewater enters the third reactor chamber of the AMBR and flows in a second direction through the third reactor chamber, the second reactor chamber, the first reactor chamber and an effluent outlet for a third period of time. Wastewater enters the inlet to the second reactor chamber and flows in the second direction through the second reactor, the first reactor and an effluent outlet for a fourth period of time. A mass load of the particulate chemical oxygen demand to the second reactor chamber (i) in the first direction of flow during the first and the second periods of time while the third reactor chamber acts as a clarifying chamber, and (ii) in the second direction of flow while the first reactor chamber acts as a clarifying chamber during the third and the fourth periods of time, allows for substantially complete digestion of biodegradable loads of the particulate chemical oxygen demand and the soluble chemical oxygen demand.

### CROSS-REFERENCE TO RELATED APPLICATIONS

This U.S. non-provisional application claims the benefit under 35 U.S.C. § 119(e) to U.S. Provisional Patent Application No. 63/509,490, filed Jun. 21, 2023 and to U.S. Provisional Patent Application No. 63/425,305, filed Nov. 14, 2022, the entire disclosures of both applications are incorporated herein by reference.

### BACKGROUND OF THE INVENTION

### Field of the Invention

The invention relates to wastewater treatment, and particularly to wastewater treatment of wastewater having a high particulate chemical oxygen demand (PCOD). The invention further relates to a reactor system and method of using the same to carry out such high PCOD wastewater treatment, and more particularly to the use of an anaerobic migrating blanket reactor (AMBR).

### Description of Related Art

Anaerobic processes are known for use in the treatment of industrial and domestic wastewater. Typical examples of commercial prior art systems for anaerobic treatment methods include use of upflow anaerobic sludge blanket (UASB) reactors, in which wastewater with biological or organic material (i.e., material coming from or made of plants or animals) is introduced through the bottom of a UASB bioreactor so that it passes upwardly through a suspended sludge blanket for anaerobic digestion by anaerobic microorganisms (anaerobes) in the sludge and operates in an oxygen-free environment. The UASB incorporates a high concentration of microbial biomass by granulation. See, M. Vitĕzová et al., “Methanogenic Microorganisms in Industrial Wastewater Anaerobic Treatment,” Processes, vol. 8, 1546, pp. 1-27 (2020). The anaerobic microorganisms break down the organic material in the wastewater by breaking down the organic material into smaller volatile organic acids which then form hydrogen, carbon dioxide and acetate which are converted by the microorganisms into methane gas and carbon dioxide byproducts. UASB reactors are known to be useful in wastewater treatment when there is a highly soluble substrate. When higher loads of organic materials are present, expanded granular sludge beds (EGSB) have been used which are similar to UASB reactors but recirculate the wastewater for greater contact.

More recently reactors have been developed that are used for industrial waste competitively to UASB reactors known as internal circulation (IC) anaerobic reactors. These reactors receive wastewater in the bottom which is immediately circulated with a sludge bed having biomass and incorporate within the reactor different levels of biogas deflection as the feed water moves upwardly in a circulated manner. The reactor incorporates a “polishing” or separation treatment section, where some biogas is sent to a phase separator, and a second separation area treating remaining upflow water with a lower pollutant level above the first separation area. Each of the separation areas has horizontally extending capped separators that direct biogas through a conduit to an upper phase separator, from which biogas is removed. Clean effluent is removed and a portion of the water passing upward separated from the biogas is recirculated downward into the lower treatment area. See, M. Vitĕzová et al., supra, FIG. 6 and Biopaq®IC, described at https://en.paques.nl/products/featured/biopaq-anaerobic-wastewater-treatment/biopaqic.

Other prior art anaerobic bioreactors include baffled reactors which were also developed for improving contact with the anaerobes in the sludge. These are known as anaerobic baffled reactors (ABR). Baffles are introduced to create compartments that operate to allow the wastewater to flow over a baffle from one “compartment” demarcated by the baffle into another. Other systems include the anaerobic sequencing batch reactor (ASBR) which is a batch-fed process without a hydraulic up-flow pattern.

U.S. Pat. No. 5,855,460 describes a reactor for wastewater treatment known as an anaerobic migrating blanket reactor (AMBR). The system was described as not requiring a gas-solids separator or a complex feed distribution system. The AMBR as described does not require effluent recycling, but requires mixing to obtain biomass/substrate contact. The reactor includes stages in which all phases of anaerobic digestion are present, but in an initial compartment, there is a higher level of acidogenic activity. Baffles may be placed in front of the effluent port to reduce the amount of floating granules leaving the reactor. (See, U.S. Pat. 5,855,460, col. 4). Flocculent biomass was described as migrating faster through the system than granular biomass, and so that it is eventually responsible for the wash out of less settleable flocculent biomass from the reactor. (See, U.S. Pat. 5,855,460 Abstract). It describes flow from a first compartment to a third compartment and reversed flow from the third compartment to the first. While this patent was not commercialized, it was designed to work on wastewater having a high soluble chemical oxygen demand (SCOD).

Of concern in certain prior art reactors is the potential loss of biomass with effluent from the reactor due to excessive bed expansion and from poor granulation of the biomass.

Not all wastewater has a total chemical oxygen demand (TCOD) that is primarily or solely SCOD organic materials. Instead, TCOD also includes particulate chemical oxygen demand (PCOD) material. High PCOD fractions present additional challenges in anaerobic treatment processes. For example, they are typically less biodegradable, which means that there is accumulation of indigestible and non-productive sludge solids in the reactor that will increase over time, thereby reducing the available volume for active sludge solids or biological volatile suspended solids (bioVSS) and interfering with the formation and selection of granules. This type of effect can occur in high PCOD content feedstock such as that from dairy farms where manure waste is processed. Further, such wastewater can have varying levels of dilution, e.g., water and solids content in the wastewater influent may vary during hot weather as sprinklers are used to cool livestock such as cows. The sprinklers incorporate more water in flushed wastewater containing manure; whereas less water would be present in cool or colder weather, which is experienced also in industrial applications involving slaughterhouses. See, M. Vitĕzová et al., supra, at pages 12, 15. Conditions in dairy and agricultural industrial applications can also vary due to rainfall and other issues.

### BRIEF SUMMARY OF THE INVENTION

The invention herein provides a practical wastewater treatment apparatus that can be used for high PCOD wastewater and/or in end applications in which the wastewater content and dilution levels vary, to enable use of anaerobic digestors in industrial, agricultural and other settings using wastewater influent of a greater diversity in terms of its SCOD and PCOD content and in terms of its dilution levels, for use, for example in the dairy, agricultural, slaughterhouse and other similar industrial and other uses.

The invention is able to treat wastewater, and particularly wastewater having a high particulate chemical oxygen demand, and provides a reactor system and method of using the same to carry out such PCOD wastewater treatment. The apparatus is exemplified and referred to herein as an anaerobic migrating blanket reactor or “AMBR”.

The invention includes embodiments of a method of treating wastewater comprising soluble chemical oxygen demand and particulate chemical oxygen demand, comprising: (a) providing an anaerobic migrating blanket reactor apparatus having a structure that has at least one inlet for wastewater influent in a lower portion thereof, at least one biogas outlet in an upper portion thereof, at least one sludge drain, and at least one outlet for removal of effluent, wherein the structure of the anaerobic migrating blanket reactor defines at least three reaction chambers comprising a first reaction chamber, a second reaction chamber and a third reaction chamber, and wherein the at least three reaction chambers are configured to permit bidirectional, generally transverse flow, in a first direction and a second direction, through the at least three reaction chambers; (b) introducing wastewater influent into the at least one inlet so as to enter the first reactor chamber of the anaerobic migrating blanket reactor and flowing the wastewater in a first direction through the first reactor chamber, the second reactor chamber, the third reactor chamber and through the at least one effluent outlet for a first period of time; (c) introducing the wastewater influent into the at least one inlet so as to enter the second reactor chamber of the anaerobic migrating blanket reactor and flowing the wastewater in the first direction through the second reactor, the third reactor and through the at least one effluent outlet for a second period of time; (d) introducing the wastewater influent into the at least one inlet so as to enter the third reactor chamber of the anaerobic migrating blanket reactor and flowing the wastewater in a second direction through the third reactor chamber, the second reactor chamber, the first reactor chamber and the at least one effluent outlet for a third period of time; and (e) introducing the wastewater influent into the at least one inlet so as to enter the second reactor chamber and flowing the wastewater in the second direction through the second reactor, the first reactor and the effluent outlet for a fourth period of time, wherein a mass load of the particulate chemical oxygen demand to the second reactor chamber (i) in the first direction of flow during the first and the second periods of time while the third reactor chamber acts as a clarifying chamber, and (ii) in the second direction of flow while the first reactor chamber acts as a clarifying chamber during the third and the fourth periods of time, allows for substantially complete digestion of biodegradable loads of the particulate chemical oxygen demand and the soluble chemical oxygen demand.

In one embodiment of the method, a mass load of the particulate chemical oxygen demand to the first reactor chamber during the first period of time in the first direction of flow may be limited such that the particulate chemical oxygen demand and the soluble chemical oxygen demand are converted and biogas production minimized before the first reactor chamber becomes a clarifying chamber upon initiation of the third period of time and reversal of flow to the second direction. Further, in another embodiment, after step (e), steps (b) through (e) may be repeated at least once, and a mass load of the particulate chemical oxygen demand to the third reactor during the third period of time in the second direction of flow may be limited such that the particulate chemical oxygen demand and the soluble chemical oxygen demand are converted and biogas production minimized before the third reactor chamber becomes a clarifying chamber upon initiation of the first period of time and reversal of flow to the first direction in the repeated step (b).

In another embodiment, the total of the second period of time and the fourth period of time may be equal to or greater than either the first period of time or the third period of time.

In the method, the wastewater influent may have a PCOD content of at least about 15 percent of the TCOD. The wastewater influent may have a variable PCOD content, and may be for example wastewater comprising flushed dairy manure. In one embodiment, the method may have an organic loading rate of about 2.5 kg COD/m³/day to about 5.5 kg COD/m³/day.

The anaerobic migrating blanket reactor structure preferably has at least a first reactor vessel including the first reactor chamber, a second reactor vessel including the second reactor chamber and a third reactor vessel comprising the third reactor chamber. Each of the first reactor vessel and the third reactor vessel are preferably in fluid communication with the second reactor vessel. In such an embodiment, the method may further comprise providing bidirectional, generally transverse flow through the first, the second and the third reactor vessels. A first conduit may be provided extending from the first reactor vessel to the second reactor vessel and a second conduit may be provided extending from the second reactor vessel to the third reactor. In such an embodiment, the method further comprises providing bidirectional, generally transverse flow through the first and the second conduits.

The anaerobic migrating blanket reactor structure may further comprise generally longitudinally extending members for directing flow, wherein such members are positioned within the first, second and third reactor vessels near the ends of the first and the second conduits. In such configuration, the method may further comprise directing biogas upward and sludge downward within the reactor vessels guided at least in part by the generally longitudinally extending members. The first conduit and the second conduit may also be positioned such that at least a first end of the first conduit and a first end of the second conduit is respectively vertically positioned between a middle of and a top of the first reactor vessel and a middle of and a top of the second reactor vessel. The first conduit and the second conduit may each extend horizontally. It is also possible that the second end of the first conduit and a second end of the second conduit are each respectively positioned vertically near a bottom of the second reactor vessel and near a bottom of the third reactor vessel.

In another embodiment, the anaerobic migrating blanket reactor may further comprise a third conduit extending between the first reactor vessel and the second reactor vessel and a fourth conduit extending between the second reactor vessel and the third reactor vessel, wherein a first end of the third conduit and a first end of the fourth conduit may each be respectively vertically positioned near a bottom of the first reactor vessel and near a bottom of the second reactor vessel, and a second end of the third conduit and a second end of the fourth conduit may be respectively vertically positioned between a middle of and a top of the second reactor vessel and a middle and a top of the third reactor vessel.

The anaerobic migrating blanket reactor may also further comprise a third conduit extending between the first reactor vessel and the second reactor vessel and a fourth conduit extending between the second reactor vessel and the third reactor vessel. In such a configuration, a first end of the third conduit and a first end of the fourth conduit may be respectively vertically positioned near a bottom of the first reactor vessel and a bottom of the second reactor vessel and the third conduit and the fourth conduit may extend horizontally.

The anaerobic migrating blanket reactor may, in another embodiment, further comprise a third conduit extending between the first reactor vessel and the third reactor vessel and at least one of the effluent outlets may be positioned on the second reactor vessel. Such configuration may be used in situations in which a reactor is out of service and a bypass to a different reactor is indicated.

In a further embodiment, the anerobic migrating blanket reactor structure in the method may be a single reactor vessel having walls therein to isolate within the vessel at least the first reactor chamber, the second reactor chamber and the third reactor chamber.

In a further embodiment of the method, the anaerobic migrating blanket reactor structure may comprise a baffle and diverter, wherein the at least one outlet for removal of effluent in the anaerobic migrating blanket reactor apparatus comprises an opening in the structure of the apparatus in fluid communication with outlet pipe, and the method further comprises providing the baffle positioned around the outlet opening within the apparatus, directing effluent toward the outlet opening, and providing the diverter positioned to divert biogas around the baffle.

In another embodiment, the anaerobic migrating blanket reactors used in various embodiments herein may further comprise a stirring mechanism within each reactor (or each reactor chamber), such as the first reactor chamber, the second reactor chamber and the third reactor chamber, and the method may further comprise stifling the fluid and sludge within each of the first reactor chamber, the second reactor chamber and/or the third reactor chamber continuously or intermittently. The stirring mechanism may be an axial mixer, such as, for example, a low-shear, high-flow axial mixer. The method may further comprise operating the stirring mechanism in the first reactor chamber or the third reactor chamber, when the first reactor chamber or the third reactor chamber is acting as the clarifying chamber, less frequently than the stifling mechanism in either of the remaining reactor chambers.

In the method noted above, after step (e), steps (b) and (c) and/or steps (d) and (e) may be repeated at least once.

In one embodiment of the method about 75 percent to greater than 25 percent of total wastewater influent particulate chemical oxygen demand mass load may be introduced in the second stage during the second and fourth periods of time, or about 60 percent to about 40 percent of the total wastewater influent particulate chemical oxygen demand mass load is introduced in the second stage during the second and fourth periods of time, or about 50 percent to about 40 percent of the total wastewater influent particulate chemical oxygen mass demand load is introduced in the second stage during the second and fourth periods of time. In a further embodiment a total wastewater influent feed time may be the total time of the first, second, third and fourth periods of time, and a total of the second and the fourth periods of time may be about 75 percent to greater than about 25 percent of total wastewater influent feed time, or about 60 percent to about 40 percent of the total wastewater influent feed time, or about 50 percent to about 40 percent of the total wastewater influent feed time. In another embodiment, a loading volume of wastewater influent to the second reactor chamber may be about 75 percent to about 25 percent of a total loading volume of the wastewater influent, or about 60 percent to about 40 percent of the total loading volume of the wastewater influent or about 50 percent to about 40 percent of the total loading volume of the wastewater influent.

The method may further comprise increasing the percentage of total wastewater influent feed time to the second reactor chamber as the level of particulate chemical oxygen demand in the wastewater influent increases.

The method may further comprise at least substantially, and preferably substantially completely, digesting the soluble chemical oxygen demand in the wastewater influent in the first reactor chamber and/or the third reactor chamber. The method may also further comprise at least substantially, and preferably substantially completely, digesting a particulate chemical oxygen demand in the wastewater influent in the second reactor chamber.

The method may further comprise redistribution of sludge through the first reactor chamber, the second reactor chamber and the third reactor chamber using bidirectional flow to avoid accumulation of sludge in the first reactor chamber or the third reactor chamber, when the first reactor chamber or the third reactor chamber is acting as the clarifying chamber.

The method may further comprise operating the anaerobic migrating blanket reactor at a temperature of about 80° F. to about 100° F.

In one embodiment of the method, in the first direction of flow, the first reactor chamber and the third reactor chamber may be viewed as first and third stage reactors respectively and the second reactor chamber may be viewed as a second stage reactor for substantial digestion of particulate chemical oxygen demand, and the method may further comprise providing one or more additional second stage reactor chambers positioned between the first reactor chamber and the third reactor chamber, which may enhance digestion of PCOD. Similarly, in the second direction of flow, the first reactor chamber and the third reactor may be viewed as the third and the first stage reactors respectively and the second reactor chamber maybe viewed as a second stage reactor for substantial digestion of the particulate chemical oxygen demand, and the method may further comprise providing one or more additional second stage reactor chambers positioned between the first reactor chamber and the third reactor chamber, which may enhance digestion of the PCOD.

The method may further comprise evaluating the wastewater influent to determine: a proportion of particulate chemical oxygen demand and a proportion of soluble chemical oxygen demand in a total chemical oxygen demand, and a gross sludge yield.

The method may further comprise periodic removal of waste sludge in a controlled manner.

The invention herein may also include an anaerobic migrating blanket reactor (AMBR) for use in treatment of wastewater having both soluble chemical oxygen demand and particulate chemical oxygen demand, comprising: a structure comprising at least a first reactor vessel including a first reactor chamber, a second reactor vessel including a second reactor chamber and a third reactor vessel including a third chamber; at least one inlet for wastewater influent in a lower portion of the structure capable of introducing wastewater influent independently into the first reactor chamber, the second reactor chamber and the third reactor chamber; at least one biogas outlet in an upper portion of the structure capable of removing biogas independently from the first reactor chamber, the second reactor chamber and the third reactor chamber; at least one outlet for removal of effluent from two or more of the first reactor chamber, the second reactor chamber and the third reactor chamber and at least one sludge outlet; a mixing apparatus in each of the first reactor chamber, the second reactor chamber and the third reactor chamber; and a first conduit for providing bidirectional, generally transverse fluid flow between the first reactor chamber and the second reactor chamber and a second conduit for providing bidirectional, generally transverse fluid flow between the second reactor chamber and the third reactor chamber.

The AMBR may further comprise generally longitudinally extending members for directing flow, the members positioned within each of the first, second and third reactor vessels near ends of the first and the second conduits for directing biogas upward and sludge downward within the reactor vessels.

The first conduit and the second conduit are preferably positioned such that at least a first end of the first conduit and a first end of the second conduit is respectively vertically positioned between a middle of and a top of the first reactor vessel and a middle of and a top of the second reactor vessel. The first conduit and the second conduit may be positioned to extend horizontally.

The second end of the first conduit and the second end of the second conduit may be positioned respectively vertically near the bottom of the second reactor vessel and the bottom of the third reactor vessel.

The AMBR may further comprise a third conduit extending between the first reactor vessel and the second reactor vessel and a fourth conduit extending between the second reactor vessel and the third reactor vessel, wherein a first end of the third conduit and a first end of the fourth conduit are respectively vertically positioned near the bottom of the first reactor vessel and near the bottom of the second reactor vessel, and a second end of the third conduit and a second end of the fourth conduit may be respectively vertically positioned between a middle of and a top of the second reactor vessel and a middle of and a top of the third reactor vessel.

The AMBR may further comprise a third conduit extending between the first reactor vessel and the third reactor vessel and one of the effluent outlets is positioned on the second reactor vessel, which can be used in bypass situations in which one reactor is out of service.

Optionally, the AMBR may comprise a baffle and diverter. In such an embodiment, the one or more of the at least one effluent outlet may comprise an outlet pipe in fluid communication at one end thereof with an opening defined by the structure of the anaerobic migrating blanket reactor such as an outlet opening. The structure may comprises the baffle positioned around the opening for directing effluent into the outlet pipe, and the diverter may be used for directing biogas around the baffle.

The stirring mechanism(s) used may preferably be capable of continuous and intermittent operation. The stirring mechanism(s) may be an axial mixer, such as a low-shear, high-flow axial mixer. The stifling mechanism(s) may be capable of being independently controlled.

In one embodiment, the reactor chambers of the first reactor vessel and the third reactor vessel of the AMBR, in a first flow direction, may be viewed as first and third stage reactor chambers, respectively; in a second flow direction, the reactor chambers of the first reactor vessel and the third reactor vessel may be viewed as third and first stage reactor chambers, respectively; and in the first and the second flow directions, the reactor chamber of the second reactor vessel may be a second stage reactor chamber, wherein the third stage reactor chamber may act as a clarifying chamber, and a mass load of the particulate chemical oxygen demand to the second stage reactor chamber may allow for substantially complete digestion of biodegradable loads of particulate chemical oxygen demand and soluble chemical oxygen demand in the first flow direction and in the second flow direction.

The anaerobic migrating blanket reactor may further comprise at least one or more additional reactor vessels having reactor chambers that are second stage reactor chambers and that are positioned between the first reactor chamber and the third reactor chamber.

Each of the first reactor vessel, the second reactor vessel and the third reactor vessel preferably has a wastewater influent inlet, and a biogas outlet, and one or more of the first reactor vessel, the second reactor vessel and the third reactor vessel has a sludge removal outlet, wherein each wastewater influent inlet and effluent outlet and each sludge removal outlet has an electronic open and close valve thereon. In one embodiment, the at least one effluent outlet may have an electronic open and close valve thereon.

The AMBR may further comprise: a control system in operable communication with the structure of the anaerobic migrating blanket reactor for operating an electronic open and close valve for the flow of wastewater influent fed into the at least one inlet in the lower portion thereof and for operating an electronic open and close valve for flow of effluent through the at least one effluent outlet. The control system may also be in operable communication with the at least one stifling mechanism.

In other embodiments, the anaerobic migrating blanket reactor, one or more of the reactor vessels may comprise an inflatable cover. Such inflatable covers may be a dome, a modified dome-like structure or a structure that appears toroidal or as a modified toroidal structure in transverse cross-sectional view among other designs. A stifling mechanism may be positioned and supported by a work platform centrally aligned with the toroidal inflatable cover. In such an embodiment, one or more of the reactor vessels may also include a further support structure, such as cross-beams and columns or a free-standing structure to further support a stifling mechanism and/or the inflatable cover. The structure may also comprise one or more horizontal mixers mounted on one or more mixer access structures positioned on a periphery of the inflatable cover and/or reactor vessel depending on the shape of the inflatable cover and/or if the use of additional horizontal mixers is indicated in a given reactor vessel design within the embodiments herein.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a representative diagram of an anaerobic migrating blanket reactor apparatus according to an embodiment herein in an embodiment of a method herein in which influent wastewater flow passes through the first reaction chamber, the second reaction chamber and the third reaction chamber of the apparatus in a first direction and then to an effluent outlet;

FIG. 2 is a representative diagram of the anaerobic migrating blanket reactor apparatus according to the embodiment of FIG. 1 in an embodiment of the method herein in which after the flow in FIG. 1, influent wastewater flow passes through the second chamber and the third chamber of the apparatus in the first direction and then to an effluent outlet;

FIG. 3 is a representative diagram of the anaerobic migrating blanket reactor apparatus according to the embodiment of FIG. 1 in an embodiment of the method herein in which after the flow in FIG. 2, influent wastewater flow passes into the third reaction chamber and flows in a second direction from the third reactor chamber to the second reaction chamber and to the first reactor chamber, and then out an effluent outlet;

FIG. 4 is a representative diagram of the anaerobic migrating blanket reactor apparatus according to the embodiment of FIG. 1 in an embodiment of the method herein in which after the flow in FIG. 3, influent wastewater passes to the second reaction chamber and flows in the second direction from the second reaction chamber to the first reaction chamber and out an effluent outlet;

FIG. 5 shows a sectional view of reactor vessels defining reaction chambers in an embodiment as in FIG. 1 with first and second conduits connecting the flow between the first reactor vessel and the second reactor vessel and between the second reactor vessel and the third reactor vessel;

FIG. 6 shows a sectional view of an effluent outlet in the form of a sludge drain;

FIG. 7 shows a cross-sectional view of the second reactor vessel as in the embodiment of FIG. 1 incorporating a stirring mechanism therein;

FIG. 8 shows the cross-sectional view of reactor vessels 1 and 3 of FIG. 1, incorporating an optional baffle and diverter near the effluent outlet thereof;

FIG. 9 shows an enlarged cross-sectional view of the baffle and diverter of FIG. 8;

FIG. 10 shows a top plan view of the enlarged view of the baffle and diverter of FIG. 9;

FIG. 11 shows a front elevational view of the baffle and diverter in the enlarged view of the baffle and diverter of FIG. 9;

FIG. 12 shows an alternative flow conduit configuration according to one embodiment of the invention in the first direction;

FIG. 13 shows the alternative flow conduit configuration according to the embodiment of the invention of FIG. 12 in the second direction;

FIG. 14 shows a top plan schematic view of an installation of an anaerobic migrating blanket reactor according to an embodiment herein in an industrial setting;

FIGS. 15A, 15B and 15C show various potential alternative configurations of single reactor vessel designs with multiple interconnected chambers having separating baffles or walls;

FIG. 16 shows representative longitudinal cross-sectional views of an embodiment herein with an inflatable biogas collection cover on reactor vessels for use with the AMBR apparatus and in the method herein;

FIG. 17 shows a top elevational view of an embodiment of an AMBR reactor vessel with an inflatable biogas collection cover having a toroidal transverse cross-sectional configuration and incorporating support beams and support columns therein;

FIG. 18 shows a side elevational view of the embodiment of FIG. 17;

FIG. 19 shows a top elevational view of a modified embodiment of the AMBR reactor vessel having a toroidal inflatable biogas cover of FIG. 17 but incorporating an internal free standing frame to support a mixer;

FIG. 20 shows a side elevational view of the embodiment of FIG. 19;

FIG. 21 shows a top elevational view of a further embodiment of an AMBR reactor vessel having a toroidal inflatable biogas cover as in FIG. 17, but without the structural adaptations of FIG. 17 within the tank and incorporating a central walkway below the top of the cover forming it into two halves;

FIG. 22 shows a side elevational view of the embodiment of FIG. 21;

FIG. 23 shows a top elevational view of a further embodiment of an AMBR reactor vessel with an inflatable dome cover modified to incorporate installation of side mixers within the vessel; and

FIG. 24 is a side elevational view of the embodiment of FIG. 23.

### DETAILED DESCRIPTION OF THE INVENTION

The invention herein relates to the field of anaerobic wastewater treatment and describes various embodiments of an improved AMBR apparatus having a structure as described herein as well as a method of treating wastewater anaerobically using an AMBR apparatus. In particular, the process and apparatus are intended to expand the opportunities to use anaerobic wastewater treatment to industrial end applications in which there is not only SCOD, but also there is a higher than typical level of PCOD in the wastewater to be treated. Such higher levels of PCOD are known in certain dairy and agricultural applications where there is manure or other organic matter and varying dilutions of water in the wastewater to be treated that is impacted by seasonal issues as noted in the Background section hereof. The method and AMBR embodiments herein enable a flexible approach to anaerobic digestion in such situations and can be used in varying ratios of SCOD and PCOD, including situations having at least about 15 percent or more PCOD of the total COD, and which may also have a low contribution of active sludge, i.e., a low biomass (low level of biological volatile suspended solids (bioVSS)). The use of a low-loaded third stage reactor chamber allows for sludge to settle while maintaining forward flow which is an advantage over prior art reactors such as sequenced batch reactors (SBRs).

The method and apparatus herein have the advantages of avoiding the need for a three-phase separator (gas, liquid, solid separator, or GLSS) and a feed distribution system. Intermittent mixing when used ensures good substrate-sludge contact without the need for a special feed distribution system. The intermittent mixing also assists the improved AMBR process and apparatus herein to enhance plug flow which provides a substrate concentration gradient favoring development of well settling sludge. Further, sludge is allowed to settle and concentrate via a selection process that favors the development and retention of well settling sludge. Power requirements are also improved by use, in preferred embodiments of intermittent mixing, reduces power costs by as much as approximately 70% or more when compared to continuously stirred tank reactor (CSTR) systems.

Of further advantage to the user is that hydraulic retention time (HRT) is independent of solids retention time (SRT) so that, for example, one may have an embodiment in which greater than about 17 days of SRT for available solids digestion may occur, at certain concentrations, while passing water through in about five or less days of HRT.

In prior art processes, some process steps are separated by reaction phase (acidogenesis versus methanogenesis), whereas the AMBR improved design herein and methods approach the process by stages. Simply separating by phase does not necessarily favor well settling methanogenic sludge. Extracellular polymeric substances (EPS) formed by acidogenic sludge are a key component in the “glue” that holds well settling heterogenous anaerobic sludge flocculants together. Thus, maintaining the migrating bed allows for this to occur more readily.

By using the periodic reversal of flow bidirectionally in the method and AMBR apparatus herein, the method and AMBR apparatus enables redistribution of sludge reasonably evenly throughout the reaction chambers in the apparatus, which ensures that both SCOD degrading sludge and PCOD hydrolyzing sludge are within each reactor chamber. The first stage reactor (which may be reactor chamber one in a first direction, or may be reactor chamber three when the first direction of flow is reversed to a second direction) functions to primarily digest SCOD in the influent wastewater and a lower amount of PCOD. Stage two (reactor chamber two or other additional second stage reactor chambers) enables primarily PCOD degradation as well as degradation of SCOD. Reversal of flow also prevents the first stage (e.g., the first reactor chamber in the first flow direction or the third reactor chamber in the second reverse flow direction) from crashing due to chronic overload. Additionally, the bidirectional flow reversal adds at least one additional mode of feast-famine operation to the process for enhanced digestion of PCOD. The first mode of feast-famine operation occurs due to positioning the reactor chambers in sequence with the first reactor experiencing an abundance of food (feast conditions) and the last stage (the third stage such as the third reactor chamber) experiencing a scarcity of food (famine conditions). Reversing the flow such that the third reactor chamber acts as a stage one reactor and the first reactor chamber then becomes a third stage reactor provides the additional mode of feast-famine by switching the feast versus famine conditions in those reactor chambers when flowing in the opposite direction. This also helps to prevent sludge accumulation in third stage reactor chambers (e.g., the third reactor in the first influent feed direction) and distributes the sludge more evenly among the reaction chambers.

It is also possible in the process herein to arrange reaction chambers and use mixing and to maintain the reactors in operation when one or two of the multiple reaction chambers is down for service such as maintenance or clean-out.

As used herein, words such as “interior” and “exterior,” “inner” and outer,” “upward” and “downward,” “inward” and “outward,” “radially” and “circumferentially,” “upstream” and “downstream,” “higher” and “lower,” “top” and “bottom,” “left” and “right,” “horizontally” and “vertically” and “distal” and “proximal” and words of similar import refer to directions in the drawings in accordance with their ordinary meaning and are for assisting in clarifying the features of the invention in view of the drawings unless otherwise specified.

As used herein “fluid communication” refers to a fluid, whether a liquid, a gas or vapor, including such states as may have solids incorporated therein (such as wastewater), flows from one component or area to another component or area, either directly, or indirectly through one or more intervening components or areas, wherein examples of intervening components may be, for example, conduits, pipes, valves, gates, doors, dividers, and areas may be open spaces such as manifolds, plenums, an openings defined in or by a component or structure such as an inlet opening or an outlet opening, a passageway through a component and the like.

Reference herein to a “reactor vessel” is intended to mean an apparatus having inlet(s) and outlet(s) and a closed interior environment defined by a structure for allowing a reaction, including those reactions involved with wastewater treatment, and particularly anaerobic wastewater treatment, to occur. Such structure may be designed in varying sizes to define a variety of volumes for the AMBR and may vary in cross-sectional shape, for example, the reactor vessel may define a cross-section that is round, oval, elliptical, square or other designed shape. Preferably the reactor vessels herein have a rounded, and preferably circular cross-sectional configuration, but the invention is not limited thereto. In addition, varying covers, lids, roofs or storage areas may be provided on the top portion of the reactor vessel, including a bio-gas storage membrane as discussed elsewhere herein.

Such “reactor vessels” are part of the overall AMBR apparatus which includes the AMBR structure along with its various optional and otherwise indicated components provided for movement and/or mixing of the wastewater to be treated in the AMBR as described herein. The reactor vessels herein may be referred to as “reactors” or “reactor vessels” and define within them one or more reactor chambers. The reactor chamber may be a single chamber defined by the reactor vessel structure or may be more than one reaction chamber separated by one or more walls, partitions or dividers as described further hereinbelow.

In the present application, reference to flow or objects extending in a direction that is “generally longitudinal” or “generally vertical” means flow occurs or objects are positioned with respect to a general up and down direction with respect to a longitudinal (vertical) plane through the apparatus or that a part is extended in that same direction. Unless otherwise indicated, it is anticipated that “generally longitudinal” incorporates within its scope both substantially longitudinal, with some margin or adjustment in angle, and substantially completely or completely longitudinal. Similarly, “generally transverse” or “generally horizontal” flow or extending components means that the flow of fluid or extension of components is generally positioned along a transverse (horizontal) plane through the apparatus and incorporates substantially horizontal flow with some margin or adjustment in angle, and also substantially completely or completely transverse.

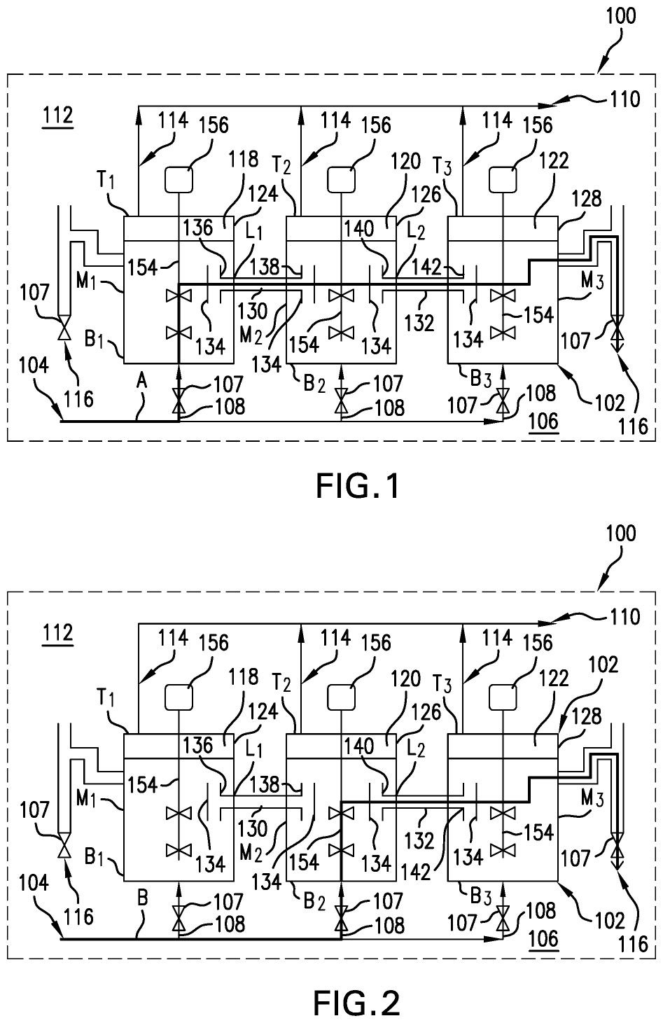

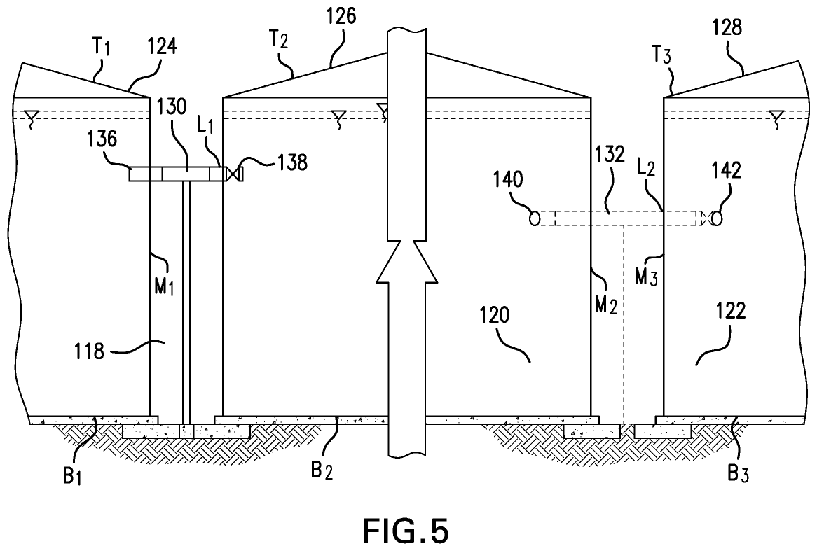

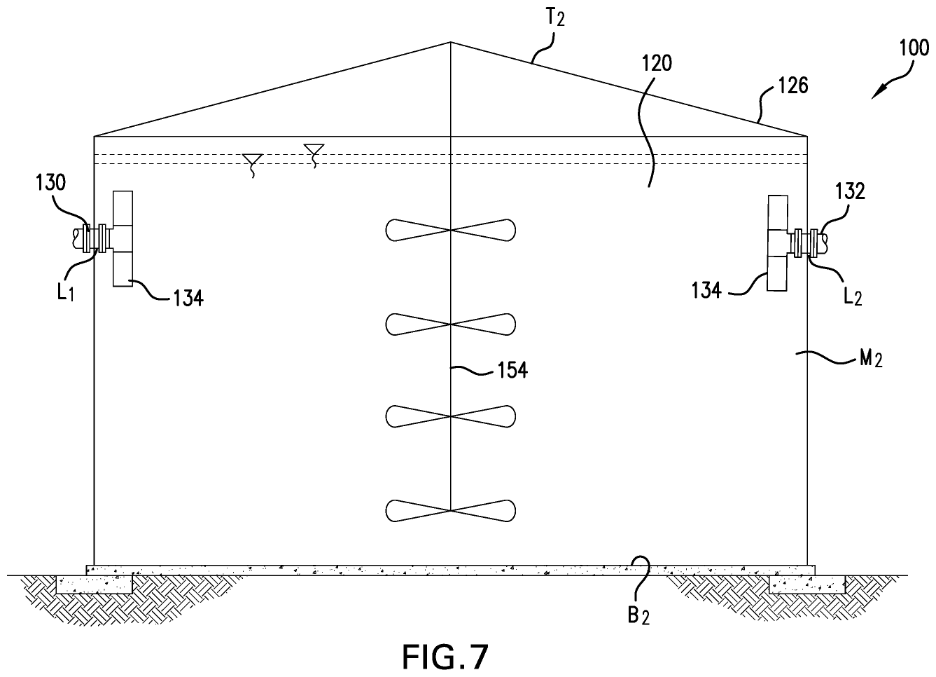

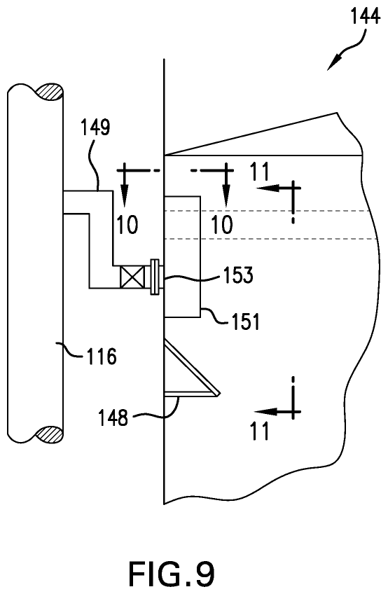

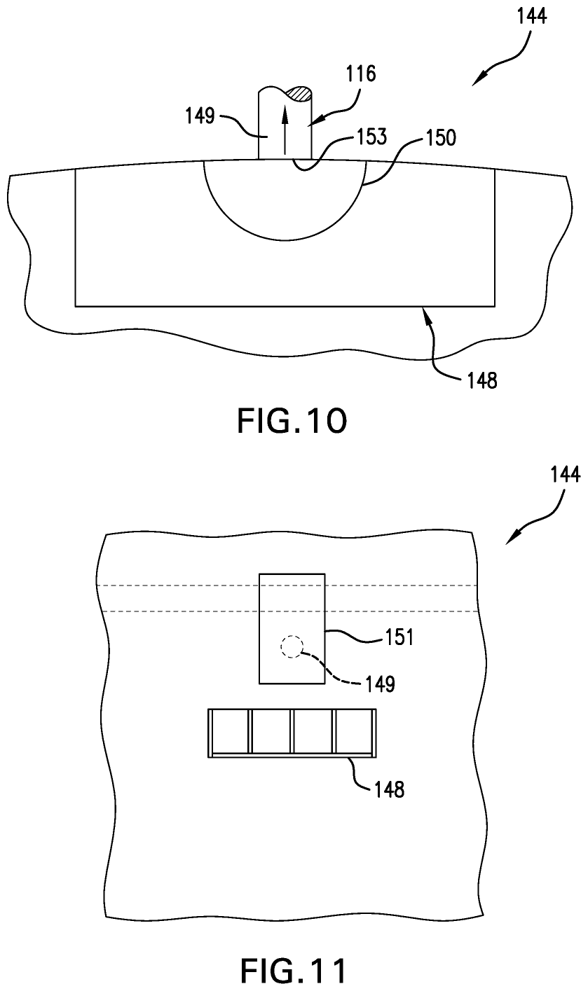

The method of treating wastewater will now be described with respect to the representative drawings of FIGS. 1-4 and the drawings of the apparatus in FIGS. 1-14 as explained in further detail below. The wastewater to be treated in the method is one in which there is both SCOD and PCOD. In preferred embodiments, the method and apparatus may be used with varying levels of SCOD and PCOD, varying levels of water dilution and operates beneficially for wastewaters having at least 15% or higher PCOD as noted above.

The method includes a first step of providing an AMBR apparatus, which will be identified in the embodiment herein as AMBR apparatus 100. The apparatus 100 has a structure 102 that has at least one inlet 104 for wastewater influent in a lower portion 106 thereof. The at least one inlet may be any inlet wastewater conduit for introducing wastewater into the reactor vessels herein. Preferably the inlet is in communication with an inlet feed or other wastewater tank apparatus, pond, lagoon or other structure for introducing wastewater to the AMBR structure 102 of the apparatus 100.

The at least one inlet 104 as shown introduces wastewater for treatment into one or branched conduits 108 into bottom inlets, however, it will be understood by one skilled in the art that parallel inlets with alternating open/close valves, branched inlets with individual open/close valves and other fluid communication configurations may be used. It is preferred, however, that whether through the bottom floor or lower side wall of the reactor vessels, that the at least one inlet 104 is capable of introducing wastewater influent into one or more openings in the reactor vessels of the AMBR as described further below. The inlet conduit may be any acceptable, standard industry piping or conduit for use in anaerobic wastewater treatment known in the art or to be developed, and is preferably one that is suitable for transporting wastewater with higher loadings of PCOD. One or more inlet open/close valves 107 which may be manually operated or electronically operated can be provided at the wastewater inlet 104 and/or on individual branched conduit 108 along the at least one inlet 104. Valves may be used for shutting flow on or off, or introduced along conduit for intermittent testing, redirection of flow and the like.

While not shown herein, other types of valves may be used, including those that are hydraulic, controllable or used for other purposes (such as testing or monitoring conditions) within the scope of the disclosure.

In the method herein, wastewater influent is introduced to the reactor chambers 118, 120 and/or 122 in a preferably continuous manner so as to control the flow of sludge and wastewater through the AMBR structure. Intermittent introduction of influent would be indicated in a situation when the feedstock runs out or cannot sustain flow. Introduction of influent can vary based on dilution, so the flow may be managed through use of an equalizer tank positioned so as to receive influent prior to its introduction to the reactor chambers.

The structure 102 of the apparatus 100 also includes at least one biogas outlet 110 in an upper portion 112 thereof. As with the wastewater influent, a number of conduit configurations may be used for allowing the removal and collection of biogas formed during anaerobic treatment in the AMBR, including, for example, removal and collection of carbon dioxide and/or methane. As shown, branched conduit 114 may be used for collecting biogas from each of several reactor vessels which can be removed individually in separate parallel outlets or consolidated to one common biogas outlet within the scope of the disclosure as would be readily understood by one skilled in the art. Suitable conduit and piping should be that which is standard, approved biogas collection piping known for use or to be developed in the anaerobic wastewater treatment arts.

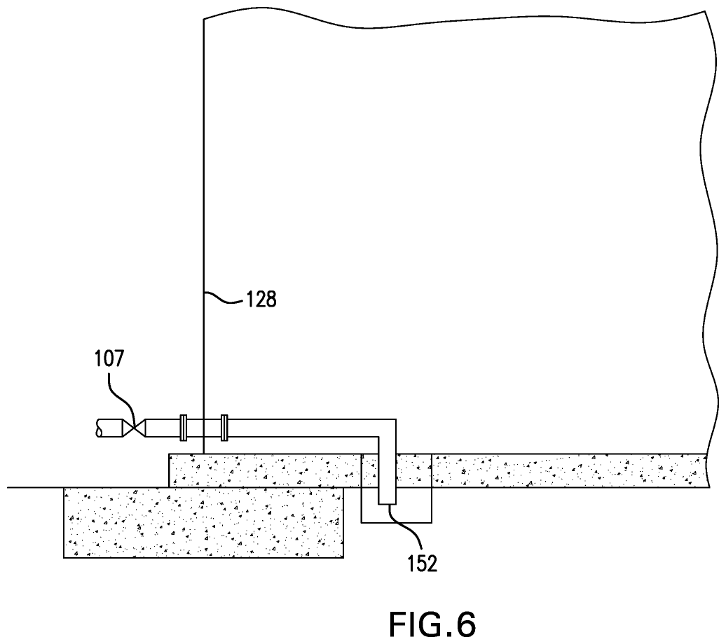

The structure 102 also includes at least one outlet 116 for removal of effluent and one or more outlets 152 for removal of sludge. In the embodiment shown in FIGS. 1-4, there are two effluent outlets (one from each of the first and third reactor vessels, however, such effluent outlets may be consolidated to one outlet, or there may be more than one outlet, for example, the reactor vessels may each have an individual outlet, a sampling port or other openings for removal of effluent and the like from the reactor vessels. Further, at least two and optionally all reactor vessels in the structure may have an outlet 152, as best seen in FIG. 6, for removal of sludge, whether as part of the process, for testing or other purposes. One or more open/close valves 107 or other valves as noted above with respect to the at least one wastewater influent inlet 104, may be used also within conduit for the at least one effluent outlet(s) and for the one or more sludge outlets.

The structure of the AMBR defines at least three reaction chambers, a first reaction chamber 118, a second reaction chamber 120 and a third reaction chamber 122. These may also be viewed as first stage, second stage and third stage reactor chambers, when flow is in a first direction, or respectively, third stage, second stage, first stage reaction chambers when flow is in a second or opposite direction from the first direction. In the method, the second reaction chamber, or second stage reactor is preferably employed to provide the most significant level of PCOD degradation as will be explained further herein. However, due to the ability to highly load the second stage volumetrically, it is possible to expand the second stage to include more than one such reactor. Thus, while there are at least three reactor chambers, there may be multiple reaction chambers optionally incorporated in the process, particularly duplicative stage two reaction chambers 120 and/or positioned between the two end reactor chambers 118, 122 that are in stages one or three depending on the direction of flow. Such multiple additional reactor chambers may be used to enhance SRT as well as increase the volume available to expand system capacity and adjust to the growth in mass loading over time. When incorporating multiple such reaction chambers particularly in stage two, the method may also enhance PCOD degradation.

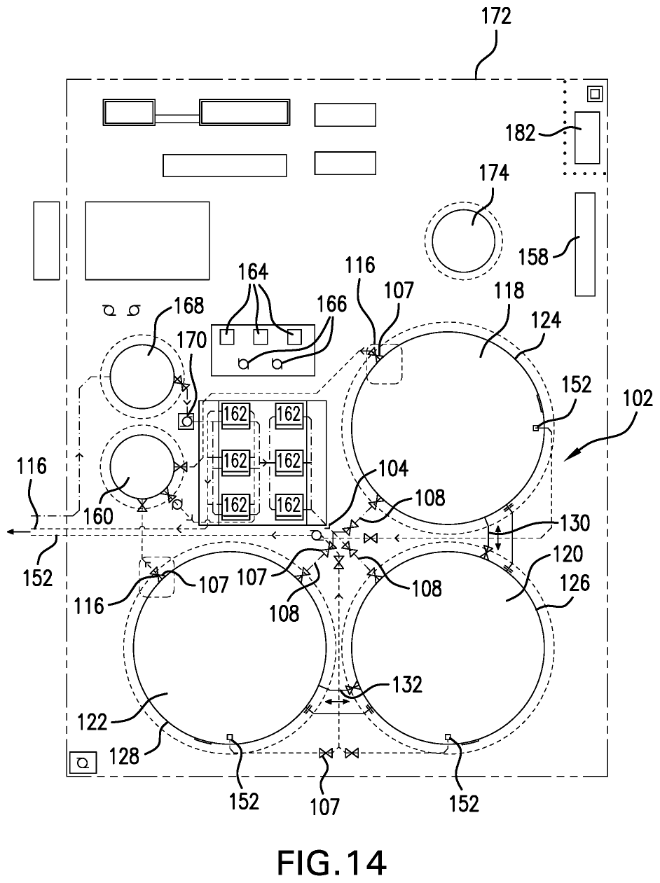

The three reaction chambers 118, 120, 122 are configured by using various conduit and feed steps to permit bidirectional, and preferably generally transverse flow, in a first direction in some steps and also in a second direction in other steps. By generally transverse flow in this instance, the flow of wastewater through the apparatus tends to go from one reaction chamber in one direction to the next and similarly is able to be flowed in the generally opposite direction during separate steps in the process, however, the reactors may be arranged in various configurations (side-by-side as shown in FIGS. 1-4 or clustered as shown in FIG. 14). Thus flow is forwarded from one reactor to the next and then later is sent backward in the opposite direction. Generally transverse in this instance also takes into account non-laminar conditions as, in some embodiments herein, at least intermittent mixing occurs in an individual reaction chamber, and also in the treatment process, there is movement upward of biogas contrary to the reactor-to-reactor bidirectional flow of wastewater. Thus, there are other elements of wastewater and biogas flow occurring within the reaction chambers while the wastewater and sludge are moving generally transversely in various steps from reaction chamber one to reaction chamber two and on to reaction chamber three, or vice versa depending on the process steps as indicated.

Wastewater with sludge content also moves through conduits or other passageways or openings into and out of the structure and through the structure from chamber to chamber. Such conduits or openings may be made to be generally horizontally (transversely) aligned for a generally horizontal path from chamber to chamber or may be positioned such that flow exits from a mid- to upper portion of the reaction chamber through a conduit angled downwardly to a lower position when entering the next reaction chamber or vice versa. Thus, while the flow continues in a single general direction (which can be bidirectional by going in an opposite direction in different steps) through the apparatus, it may also be angled in certain embodiments for flow enhancement and/or settling purposes to direct heavier sludge toward the lower portion of the reaction chambers. Accordingly, while flow passes through the structure overall in a bidirectional manner that is generally in a direction that is from chamber to chamber, it may be altered for different variations and feed paths through the AMBR structure as it passes from chamber to chamber and such variations are within the scope of this disclosure.

As shown in a general representation of a preferred embodiment of the method in FIGS. 1-4, there are shown four primary wastewater flow steps in the embodiment exemplified therein. In a first step, the wastewater influent having SCOD and PCOD that is to be treated enters through the at least one inlet 104 in FIG. 1 and enters through branches 108 into a bottom B₁ area of the first reactor chamber 118. In the first period of time t₁ in the first reaction chamber 118, the flow (shown by arrow A), flows generally transversely from a location L₁ between a middle part M₁ and a top T₁ of the first reaction chamber 118 to the second reaction chamber 120 (in this embodiment, generally transversely through horizontally extending conduit), and through the second reaction chamber 120 into the third reaction chamber 122, and then exits through an effluent outlet 116. After the first period of time, the wastewater influent is introduced into the bottom B₂ second reaction chamber (stage two) 120 and flows in the same first direction that is generally transverse from the second reaction chamber 120 into the at least one inlet thereof so as to enter the second reaction chamber 120 and then passes into the third reaction chamber 122 and out the same effluent outlet 116 for a second period of time as shown by arrow B in FIG. 2.

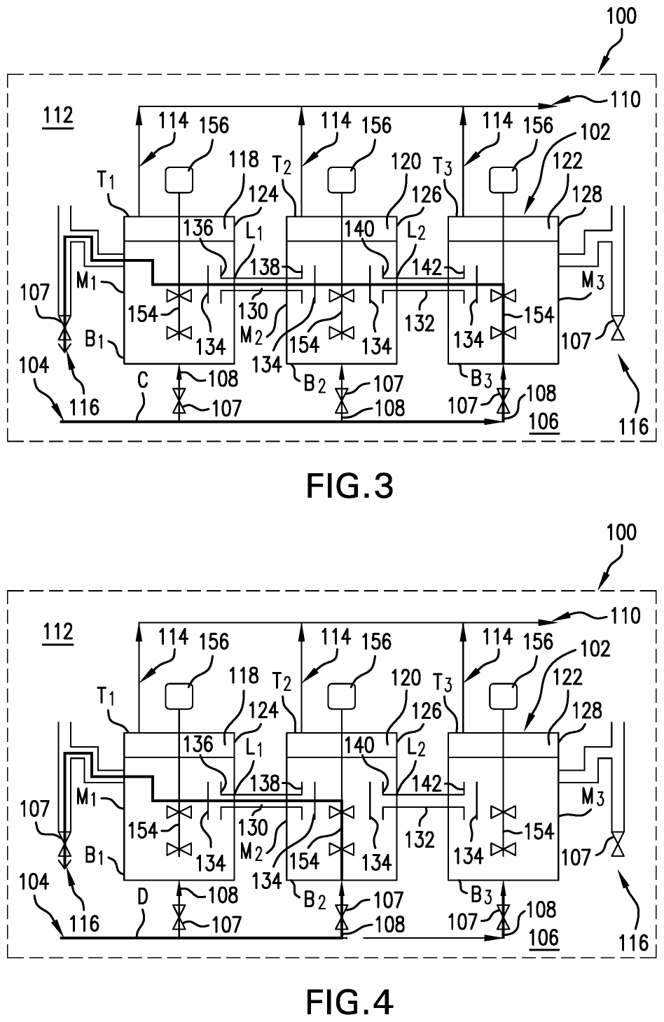

After the second period of time, the flow direction is reversed to an opposite or second direction that is also generally transverse flow but in the reverse order. Influent wastewater is fed from the at least one inlet 104 to the third reaction chamber 122 through a branch 108 and flows into the bottom B₃ of the third reaction chamber, and then from the third reaction chamber to the second reaction chamber 120 and then to the first reaction chamber 118 before exiting the effluent outlet 116 on the opposite side of the structure according to arrow C as shown in FIG. 3. This flow continues for a third period of time, and then flow is again altered as shown in FIG. 4 to enter from the at least one inlet 104 to the second reaction chamber 120 and flows from there through the first reaction chamber 118 and the same effluent outlet 116 in the same direction as the flow in FIG. 3 as shown by arrow D of FIG. 4. The flow in FIG. 4 continues for a fourth period of time. The total time in each of the steps noted above in FIGS. 1-4, first, second, third and fourth periods of time represent the total time of reaction flow in the AMBR apparatus for a complete cycle, which can be repeated continuously in operation by repeating the above-noted steps in a continuous manner.

It would be understood by one skilled in the art that the times could vary and more reaction chambers could be added as noted above and that further steps may be added to the process, for example, any of the steps may be repeated more than once. In one embodiment, the steps shown in FIGS. 1 and 2 and/or the steps in FIGS. 3 and 4 may each be repeated more than once such that total cycle time includes the total time spent loading the various reaction chambers when flowing the wastewater using the directional paths demonstrated or as modified by repeating steps. The steps should be carried out until the optimal or targeted amount of SCOD and PCOD degradation is achieved by monitoring the sludge content and evaluating the sludge yield.

It is preferred that in the flow steps of the method noted above, the sum of the second period of time and the fourth period of time (where the second chamber is loaded) is preferably equal to or greater than either the first period of time or the third period of time. Essentially, the process flows bidirectionally to avoid overloading in the first reaction chamber where significant SCOD is removed, and the reversing of flow from the third reaction chamber in the second direction avoids overuse of active reaction in the first reaction chamber. In the overall process, loading time in the second chamber is maximized in a balanced manner so as to destroy the higher levels of PCOD in the wastewater while also degrading SCOD. The wastewater influent used may be such that the PCOD content is at least about 15 percent of the total COD and potentially higher up to about 90 percent to about 95 or even approaching as high as 100 percent. The wastewater influent may have a variable PCOD content, and may be for example wastewater comprising flushed dairy manure, agricultural waste or other similar high solids waste. In one embodiment, there is a total organic loading rate of about 2.5 kg COD/m³/day to about 5.5 kg COD/m³/day, however, other loadings rates occur in different process situations depending on the quality of the resulting sludge inventory. Thus, the rates may be lower, such as 2.0 kg COD/m³/day or higher such as 6.0 kg COD/m³/day for higher quality sludge inventory (i.e., when there are higher levels of bioVSS).

As noted above, AMBR structure in a preferred embodiment, the three reactor chambers 118, 120 and 122 are each defined in configuration and volume by their respective reactor vessels. The first reactor vessel 124 defines the first reactor chamber 118, which may be a first stage reactor chamber for receiving wastewater influent in a first flow direction and in reverse flow, may operate as a third stage reactor chamber. As a first stage reactor it operates to primarily degrade SCOD and as a third stage reactor (in the reverse flow direction) may operate for settling and clarifying. The second reactor vessel 126 defines the configuration and volume of the second reactor chamber 120 which is situated to be a second stage reactor and operated to handle a higher loading of PCOD along with some SCOD. The third reactor vessel 128 defines the configuration and volume of the third reactor chamber 122. The third reactor chamber 122 in a first direction has a minor role in degradation of PCOD and SCOD and primarily acts for settling and clarifying. Then when flow is reversed it operates as a first stage reactor in the opposite direction of flow to receive wastewater influent and degrade primarily SCOD.

Each of the first reactor vessel 124 and the third reactor vessel 128 are in fluid communication with the second reactor vessel 126. As such, the method includes providing preferred bidirectional, generally transverse flow through the first, the second and the third reactor vessels in a first direction and then reversing the direction to a second direction wherein flow is opposite that of the first direction. A first conduit 130 is shown as extending from the first reactor vessel 124 to the second reactor vessel 126 for this purpose at location L₁ noted above. There is a further, second conduit 132 that extends from the second reactor vessel 126 to the third reactor vessel 128 at a location L₂ shown in this embodiment as beginning between a middle point M₂ and the top T₂ of the second reactor vessel 126. The method may thus provide bidirectional flow in a generally transverse flow direction in one embodiment through the first and the second conduits 130 and 132. The first and second conduits in this position facilitates increased sludge concentration in the reactors while allowing the sludge to move freely between reactor tanks, particularly when using intermittent or continuous mixing.

As sludge and some particulate as well as biogas is entrained in the flow through conduits 130, 132, in one embodiment, wherein biogas may be directed upward before entering the conduit(s) 130, 132 or when leaving the conduit(s) 130, 132 while some particulate is directed downwardly through use of generally longitudinally extending members 134. Such members 134 may be vertical or angled, and may be one or more components. A T-pipe or a T-pipe fitting may be releasably attached or part of the conduit(s) 130, 132 for this purpose. Extended or suspended baffles or weirs connected to the interior of the reactor vessels could also be used for this purpose. Such longitudinally extending members 134 allows for the slowing of migration of sludge between reactor vessels thus aiding in sludge concentration as discussed further herein below. The members 134 also reduce the risk of horizontal short-circuiting between the reactor vessels allowing for biogas to pass vertically through the members 134 to move above the liquor to exit through the biogas outlet(s). The members also allow a portion of the liquid flow downward into the sludge blanket increasing contact with bacteria.

As shown the longitudinally extending members in FIGS. 1-4 are vertical T-piping positioned so as to be arranged within each of the reactor vessels 124, 126, 128 near the first end 136 and the second end 138 of the first conduit 130 and near the first end 140 and the second end 142 of the second conduit 132. The method thus directs biogas upward and sludge downward within the reactor vessels 124, 126, 128 in the chambers 118, 120, 122 thereof and by guiding the biogas and sludge at least in part using the generally longitudinally extending members 134. The first and second conduits 130, 132 are shown in a generally horizontally extending configuration as in FIGS. 1-4 and extend horizontally between locations L₁ and L₂.

In an alternative conduit configuration 100′, the first and second conduits 130′, 132′ may also be configured and positioned such that flow through the first end 136′of the first conduit 130′ and a first end 140′ of the second conduit 132′ are each respectively vertically positioned between a middle of M₁ and a top of T₁ of the first reactor vessel 124′ (an upper position P₁) and between a middle of M₂ and a top of T₂ of the second reactor vessel 126′ (an upper position P₂) similar to the embodiment 100. However, it is also possible that the second end 138′ of the first conduit and a second end 142′ of the second conduit 132′ are each respectively positioned vertically near a bottom B₂ of the second reactor vessel 126′ (a lower position P₃) and near a bottom B₃ of the third reactor vessel 128′ (a lower position P₄). This may be accomplished using a single “first conduit” and single “second conduit” that is a bent pipe or connected pipe pieces to make a singular bent conduit structure that extends from upper positions (P₁ and P₂) to lower positions (P₃ and P₄) respectively (not shown) when passing from the first reactor to the second reactor and from the second reactor to the third reactor. Such a configuration may include similar, further reverse flow bent conduit incorporated in the form of a third conduit and a fourth conduit that are identical to the first conduit 130′ and the second conduit 132′ but in the reverse configuration so that the same upper to lower position flow can be accomplished in the reverse bidirectional flow steps of the method. As these conduits are mirrored, but reversed images of those shown herein, they are not shown herein.

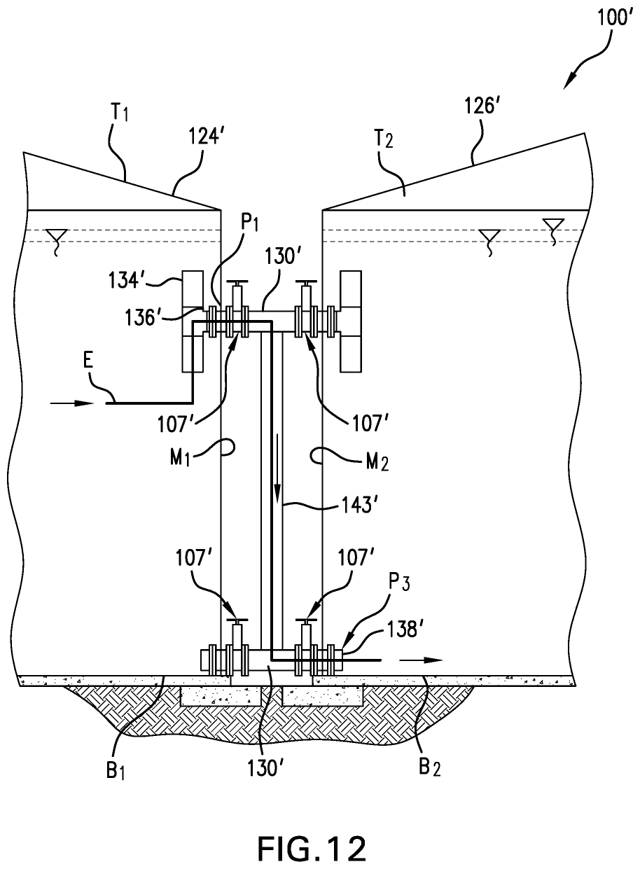

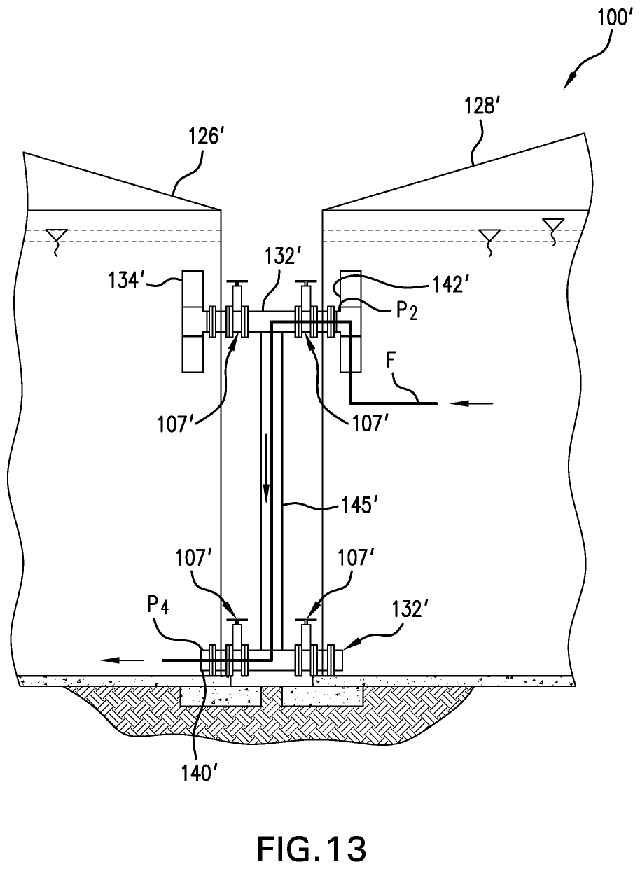

Alternatively, in the embodiment 100′ shown in FIGS. 12 and 13, instead of a single bent or multi-component bent conduit, the first and second conduits may be provided such that each incorporates two interconnected upper and lower first conduits 130′ and two interconnected upper and lower second conduits 132′ linked by a bypass conduit as shown in FIGS. 12-13 and extending between the first and second reactor vessels 124′, 126′ and between the second and third reactor vessels 126′, 128′. The upper first and second conduits may also be described as the first and second conduits (like the conduits in embodiment 100) with the lower conduits viewed as third and fourth conduits respectively. However, as they operate in the same manner, the terminology herein will refer to the upper and lower connecting conduit between the first and second reactor vessels collectively as upper and lower first conduits, and the upper and lower conduits connecting the second and third reactor vessels collectively as upper and lower second conduits for simplicity. The upper and lower conduits in the first and the second conduits 130′, 132′ each incorporate automatic valves 107′ on a left and right side thereof such that the same conduits shown may be used for forward and reverse flow in the bidirectional steps of the method.

For example, in a first flow direction E, flow is shown from left to right and may be directed from the first reactor vessel 124′ through a longitudinally extending member 134′ shown as a T-pipe into a first end 136′ of an upper first conduit 130′, then pass downwardly through bypass conduit 143′ positioned between the first and second reactor vessels to extend between the upper and lower first conduits 130′. Flow then exits the bottom of bypass conduit 143′ and into the lower first conduit 130′ and out of the second end 138′ of the lower first conduit 130′. For this flow to occur, a valve 107′ on the right hand side on the upper first conduit 130′ and a valve on the left hand side on the lower first conduit 130′ would be closed, while the valve 107′ on the left hand side of the upper first conduit 130′ and on the right hand side of the lower first conduit 130′ would be open. The upper first conduit 130′ is positioned between the middle M₁ and top T₁ of the first reactor vessel 124′ at the upper position P₁ on the upper first conduit 130′ and the lower first conduit 130′ is located near the bottom B₁ of the first conduit 130′ so that flow exits the second end 138′ of the lower first conduit 130′ at position P₃ and enters the second reactor vessel 126′. Flow would then pass in a similar manner to that shown in FIG. 12 from the second reactor vessel to the third reactor vessel using a similar flow pattern as shown by directional flow arrow E in FIG. 12. Similar valves would be in the open/close positions in second and third reactor vessels 126′, 128′ while the flow passes towards the right along arrow E. Flow would move in the same manner generally using bypass pipe 145′ shown in FIG. 13 from an upper position to a lower position into the third reactor vessel 128′.

In FIG. 13, the reverse directional flow is depicted for the embodiment 100′. In this instance flow is headed toward the left according to directional arrow F. Flow enters from the third reactor vessel 128′ in the upper second conduit 132′ through a longitudinally extending member 134′ (shown as a T-pipe) and the second end 142′ of the upper second conduit at an upper position P₂, through the open valve 107′ on the right hand side of the upper second conduit 132′, and flows downwardly through bypass conduit 145′ to the lower second conduit 132′ (as the valve on the left hand side of the upper second conduit 132′ is closed). The flow then enters the lower second conduit 132′ in which the valve on the right hand side is closed, and exits the lower second conduit 132′ through the first end 140′ of the lower second conduit 132′ at a lower position P₄ into the second reactor vessel 126′. This can then be repeated when flow passes from the second reactor vessel 126′ into the first reactor vessel 124′ using the same reverse flow pattern through the first conduits 130′. Thus, the automatic valves 107′ in each of the upper and lower conduits act automatically to reverse flow in either direction without the need for a separate and independent reverse directional bent conduit.

The use of high to low flow in embodiment 100′ between reactor vessels in either direction allows for better sludge retention in the reactor vessels while still transferring supernatant through the process and inducing upflow through the sludge blanket. When the flow reverses, the valving alternates so that the same high to low flow continues in the reverse steps.

In one embodiment hereof, if desired, the AMBR may be modified to include an additional or duplicative conduit (not shown) which may be configured as either of the first or second conduits described in embodiments 100, 100′ but that is an extra bypass conduit to extend between the first reactor vessel 124 and the third reactor vessel 128 as well as between either of the first and second reactor vessels 124, 126 or second and third reactor vessels 126, 128, wherein the duplicative conduit may be used to bypass a given reactor vessel when one or more of the vessels are shut down for maintenance or service. As such conduits are identical in type to those already shown in embodiments 100, 100′, they are not shown here.

The AMBR in such a configuration, such additional, duplicative piping for maintenance may be extended near the areas L₁, L₂ used in embodiment 100 but separated therefrom or at other locations along the reactor vessels.

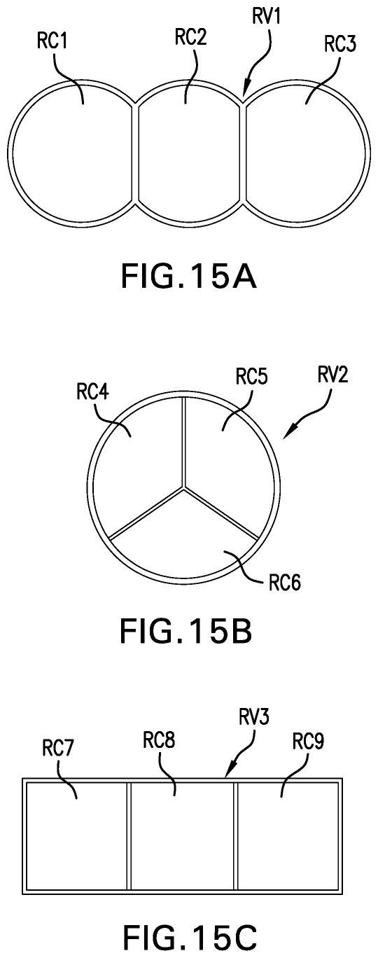

It should be understood to one skilled in the art that while the AMBR herein is created using separate reactor vessels and extended piping, the same apparatus or method may be constructed as separate chambers 118, 120, 122 within a single large vessel structure 102 in which walls defining the chambers 118, 120, 122 are within the same vessel and passageways or openings are provided between the chambers within one vessel. This embodiment is possible but would not have some of the independent operational benefits of the embodiments 100, 100′ described above in which the conduits are independent and the reactor vessels may be more easily bypassed for maintenance. In such a vessel structure 102, the anerobic migrating blanket reactor structure is a single reactor vessel having walls therein to isolate and divide space within the vessel to define at least the first reactor chamber, the second reactor chamber and the third reactor chamber. An example of a sample reactor vessel RV1 having side-by-side reactor chambers RC1, RC2 and RC3 defined by the vessel RV1 and internal dividers, where the chambers are each rounded on their interior walls along the outer perimeter in transverse cross-section is shown in FIG. 15A. FIG. 15B shows a reactor vessel RV2 having a round transverse cross-section which, with dividers, defines arcuate reactor chambers RC4, RC5 and RC6. A further sample reactor RV3 is shown in FIG. 15C which is rectangular in transverse cross section and with dividers defines reactor chamber RC7, RC8 and RC9 which may be square or rectangular as shown. Various nozzles, conduits or baffles may be used within the scope of the disclosure.

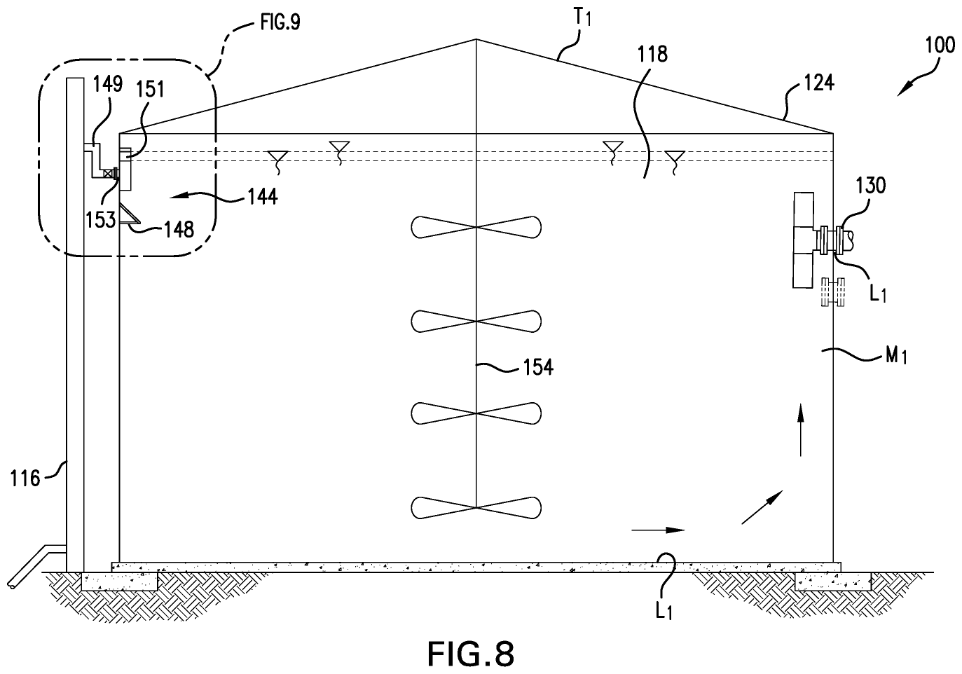

In a further embodiment of the method, the AMBR structure may comprise an optional baffle and diverter structure 144 as best shown in FIGS. 8-11. In this structure, the at least one effluent outlet 116 and its connected reactor vessel (shown here as the first reactor vessel 124) may comprise an outlet pipe 149 in fluid communication at one end thereof with an outlet opening 153 defined by the structure 102 of the AMBR, in this case in the first reactor vessel, such as an outlet opening. This same configuration could be located on any other reactor vessel in the AMBR structure 102 having an effluent outlet 116. When using the baffle and diverter structure 144, the method may further include providing the baffle structure 151 which may be a baffle plate 150, shown here with a semi-circular cross-sectional shape (half-pipe), around the opening outlet 153 and using the baffle plate 150 to direct effluent to the outlet 116 through outlet pipe 149. The diverter 148 directs biogas upward and around the baffle plate 150. The method can also include providing a baffle plate 150 that is angled outwardly if desired from bottom to top of the baffle plate 150 which may be used to slow down the upflow making it easier for solids to settle. The diverter and baffle plate may be modified for flow effects in a manner known or to be developed in the art.

The AMBR used in an embodiment herein may further comprise a stirring mechanism 154 within one or more of the reactor vessels 124, 126 and/or 128 to extend into their respective reactor chambers 118, 120, 122. The method may further include stifling the fluid and sludge within the reactor chamber(s) 118, 120, 122 continuously or, in some circumstances as noted above, intermittently. The velocity gradient used will depend on the viscosity of the wastewater. The stirring mechanism may be an axial mixer. Examples of axial mixers are preferred to be low-shear, high-flow axial mixers. The velocity gradient, number of turnovers per hour, power per unit volume (W/m³) and cloud height may be controlled and modified based on the wastewater properties as well as the particular chamber in which the wastewater is located (i.e., in a particular phase). For example, in a stage three reactor stage, turbulence can be minimized for carrying out the clarifying function. The method can thus include operating the stirring mechanism(s) 154 in the reactor chambers. In one embodiment, the stirring mechanism may be used in third stage reactor chamber 122 in the first direction less frequently than the stirring mechanism(s) in either of the first or second stage reactor chambers 118, 120 (and similarly in the third stage reaction chamber (which is a different vessel) in the reverse flow direction).

In introducing wastewater influent into the AMBR structure, in the various steps noted above including the at least four periods of time noted in the steps illustrated in FIGS. 1-4, the total wastewater influent feed time is the total loading time of all of the first, second, third and fourth periods of time (or any additional time used in repeating the steps noted above in a continuous manner). In determining the time, volume or PCOD load to be directed to the first or second stage, the purpose is to limit the PCOD load to the first stage, with some variation to a level that can be solubilized and digested before the first stage becomes the third stage when wastewater flow reverses, by diverting and/or directing more PCOD load to the second stage. This maximizes PCOD processing capacity in the second stage and prevents or minimizes accumulation of partially digested PCOD in the digestate. This results in minimizing gross sludge yield and required digester volume while maximizing digester performance and methane production.

The arrangement noted digests biodegradable mass loads of SCOD and PCOD in stage 1 before reversing flow. In general, optimal time for introducing influent to feed stages one and two will depend on the mass loads of SCOD and PCOD in the digester feedstock, as well as the biodegradability and the biodegradation kinetics of the SCOD and PCOD fractions in the particular feedstock.

Total loading time selected in the stages will depend on the wastewater influent and the PCOD load. In one embodiment, the total cycle when run by applicant was a 48 hour cycle in a high PCOD load in dairy manure which allowed for sufficient time without overloading or shut down of the reactors. The reversing of the process also helps to avoid overloading. For consistent feed, PCOD load, time and/or volume may be used to regulate the process. However, if the composition of the feedstock changes, or there is a diurnal pattern in the wastewater that modifies the feedstock, then to avoid overload, the volume concentration can be used to optimize the time, flow and load in the various stages.

During the time periods for the steps of the method in a cycle (which is repeated) in either direction feeding into the second stage (e.g., in the drawings the second reactor vessel 126 is the second stage), about 75 percent to about 25 percent of total wastewater influent PCOD load feed time is introduced in the second stage during the second and fourth periods of time, and more preferably about 60 percent to about 40 percent of the total wastewater influent PCOD load or about 50 percent to about 40 percent of the total wastewater influent PCOD load.

In addition to PCOD load, time may also be a parameter used to address the influent PCOD load, once the feedstock is assessed, and to regulate the flow stages. In scenarios where changes in wastewater flow in the AMBR process herein have relatively little impact on hourly or diurnal mass loads of SCOD and PCOD, for example in response to changes in application of dilution water, the volumes of influent to stages one and two can mirror the percentages noted above with respect to the loading times noted above. That is, the loading time of wastewater influent to the second reactor chamber may be about 75 percent to about 25 percent of a total loading time of the wastewater influent, or about 60 percent to about 40 percent of the total loading time of the wastewater influent or about 50 percent to about 40 percent of the total loading time of the wastewater influent.

Further, the total volume loading of the wastewater influent to the second reactor (second stage) in such situations may be about 75 percent to about 25 percent of the total wastewater influent volume load, or about 60 percent to about 40 percent of the total wastewater influent volume load, or about 50 percent to about 40 percent of the total volume load of the wastewater influent.

Regulating the flow stages may also be regulated using other parameters such as COD load, biogas production and the like. Time may also be used as a parameter to control volume in situations as noted above.

It will be understood to one skilled in the art, based on this disclosure, that optimizing the digestion of the biodegradable fractions of SCOD and PC OD in wastewater will depend on properly managing the mass loads of SCOD and PCOD to the first and second stages of the process herein. When the flow and composition of the wastewater represent relatively consistent SCOD and PCOD mass load to the AMBR process over time, the mass load of SCOD and PCOD to stages one and two can be effectively controlled using timers. In scenarios wherein diurnal, weekly, monthly, seasonal or other time-period dependent changes occur in wastewater flow and/or SCOD and PCOD concentration were to significantly impact diurnal or daily mass loads of PCOD, other methods of controlling the mass load of SCOD and PCOD to stages one and two of the AMBR process are indicated.

For example, in one COD load management strategy herein, wastewater flow into the AMBR apparatus may be monitored along with biogas flow and methane composition out of the AMBR apparatus. This information may be used to provide a real time indication of the mass load of COD that is being converted. In one example herein, applicant piloted the process using flushed dairy manure and established that the biogas flows from stages one and two react rapidly to their respective feeding periods demonstrating a repeating oscillation pattern of methane generation. This can be compared to the total methane generation from the AMBR process. Once the design or expected methane generating peak is reached for stage one or stage two, wastewater flow can be directed to the next step in the AMBR process.

Another example of such management combines wastewater flow with readings from a COD sensor, for example a COD probe from RealTech Inc. in Canada may be used to calculate and monitor the COD mass load arriving at the AMBR facility. The time percentages referenced previously can be applied to limit the COD mass load to stages one and two.

A further example of such management may use a microbial activity sensor, for example a Sentry sensor from Island Water Technologies in Canada, may be used to track the COD conversion capacity of the biomass in the process, which can inform the proportioning of COD mass loads into stages one and two.

It should be understood by persons schooled in the art that sensors and instruments for monitoring and control of wastewater treatment processes are continuously evolving and improving, and that appropriate sensors, instruments, and control strategies may be deployed to automate and optimize process operation if and when they become demonstrably and sufficiently accurate, robust, and reliable to be useful.

In the method herein it is preferred to increase the percentage of total wastewater influent feed time to the second reactor chamber when the level of particulate chemical oxygen demand in the wastewater influent also increases. Thus, while generally more time is indicated for PCOD degradation in stage two, in a given operation when the wastewater influent changes so that there is a higher level of PCOD, the loading time in stage two may also be increased.

In the method, the first stage, for example in entering the first reactor in the first direction of flow, it is preferred that the SCOD in the wastewater influent is substantially digested in the first stage (either the first reactor chamber in the first direction of flow and/or the third reactor chamber in a reverse flow). Substantial digestion of the PCOD in the wastewater influent occurs in the second stage, as shown, e.g., in the second reactor chamber.

The method also includes redistributing sludge through the reactor chambers 124, 126, 128 and any additional reaction chambers using the bidirectional flow described herein which avoids accumulation of sludge in the third stage reaction chambers (such as reaction chamber three in the first direction of flow).

Degradation of the SCOD and PCOD occurs more readily in the method when the reaction vessels are operated in the AMBR apparatus at a temperature of about 80° F. to about 100° F., which is optimal for active sludge growth and for the degradation reactions occurring in the stages of the AMBR.

As noted herein, in the method, the first reactor chamber and the third reactor chamber may each be viewed as a first stage or third stage reactor, depending on the flow direction, and the second reactor chamber may be viewed as a second stage reactor, and may include more duplicative second stage reactors, which are intended for use in substantial digestion of PCOD. One or more additional such second stage reactor chambers may be positioned between the first stage and third stage reactor chamber, such as the first and the third reactor chambers in the drawings to enhance digestion of PCOD.

In designing the AMBR, initially proper characterization of the wastewater, sludge yield and COD including the PCOD and SCOD levels are used to develop an intrinsically stable design. In operation using the method herein, evaluation of parameters as noted above, including, for example, influent and effluent monitoring, biogas output, sludge wasting and evaluation may be used to adjust the process as needed. For example, the wastewater influent may be evaluated to determine a proportion of PCOD and the proportion of SCOD in the total chemical oxygen demand, and also to determine the gross sludge yield which is used to evaluate the sludge quality and the proportion of digestion of the PCOD that occurs in the AMBR. Sampling in operation before and/or during the introduction of new wastewater to be treated is useful to optimize and determine the loading time needed in each stage of the AMBR. Such sampling may be controlled and the method may include periodic removal of waste sludge in a controlled manner for evaluation. Automated systems and sensors, when found to be efficient, robust and accurate, may be incorporated as well to monitor reaction conditions and for sampling operations. For example, hydraulic flow controllers and gas output may be monitored for process control. Process monitoring may include gas flow, effluent quality, sludge inventory, liquid flow, temperature, gas pressure, COD content using COD analyzers, and other system parameters and related equipment and instrumentation for monitoring wastewater treatment as are known in the art or to be developed.

The invention also includes the AMBR described above with respect to the method herein. The AMBR 100, 100′ as described is for treatment of wastewater having both SCOD and PCOD and includes the structure 102 as described above including the first reactor vessel 124 including a first reactor chamber 118, the second reactor vessel 126 including a second reactor chamber 120 and a third reactor vessel 128 including the third reaction chamber 122. The structure 102 also includes the at least one inlet 104 for wastewater influent in a lower portion 106 of the structure 102 capable of introducing wastewater influent independently into the reactor chambers 118, 120, 122. The structure also includes the at least one biogas outlet 110 in the upper portion 112 of the structure 102 capable of removing biogas independently from the reaction chambers 118, 120, 122, at least one outlet 116 for removal of effluent from two or more of the first reactor chambers 118, 120, 122 and at least one sludge outlet 152 (see FIG. 6). One or more such sludge removal outlets (such as one in each reactor vessel) may be included depending on the AMBR design. Preferably, sludge outlets which may be sludge drains are incorporated in at least the stage one and stage three reactors. The structure also includes preferably a mixing apparatus 154 in one or more of the reactor chambers 118, 120, 122. The reactor vessels 124, 126, 128 are interconnected using the first conduit and second conduits described in embodiments 100, 100′ above to provide bidirectional, generally transverse fluid flow as described herein between the first reactor chamber 118 and the second reactor chamber 120, and between the second reactor chamber 120 and the third reactor chamber 122.

In evaluating the reactor design and size needed, the content and characteristics of the waste should be assessed as well as the flow volume, herd size (for flush dairy applications), PCOD level in the TCOD, and the expected gas output and gross sludge yield.

The AMBR may also include the longitudinally extending members 134 described above for directing flow, and such members 134 may be positioned within each of the first, second and third reactor vessels 124, 126, 128 near ends 136, 138 of the first conduit 130 and near ends 140, 142 of the second conduit 132. Such members 134 direct biogas upward and sludge downward within the reactor vessels. The conduits are described in detail above in embodiments 100, 100′.

The AMBR may also include the baffle and diverter structure 144 described above wherein at least one effluent outlet 116 may comprise an outlet pipe 149 in fluid communication at one end thereof with an opening 153 defined by the structure of the anaerobic migrating blanket reactor such as an outlet opening 153 in a reactor vessel such as the first reactor vessel 124. The structure 144 may include the baffle structure 151 positioned around the outlet opening 153 for directing effluent flow towards the opening 153 and the outlet pipe 149. The structure 144 may include a diverter 148 for guiding biogas upward and around the baffle structure 151. The AMBR may include various stirring mechanism(s) 154 preferably capable of continuous and intermittent operation. The stifling mechanism(s) may be axial mixers, such as a low-shear, high-flow axial mixer, and are preferably capable of being independently controlled such as by use of time and speed controllers 156 as shown in FIGS. 1-4.

Each of the first reactor vessel, the second reactor vessel and the third reactor vessel preferably has a wastewater influent inlet such as an independent inlet 108 in communication with a primary inlet(s) 104 and a biogas outlet 110. Each inlet and outlet of each of the first reactor vessel, the second reactor vessel and the third reactor vessel may also include electronic open and close valve 107 thereon. The at least one effluent outlet 116 may also have an electronic open and close valve 107 thereon, and the at least one sludge outlet 152 may similarly incorporate such a valve as shown in FIG. 6.

With reference to FIGS. 1-11 and 14, the AMBR may further have a separate motor control center 158 which may include a control system and operator station in operable communication with the structure 102 of the AMBR for operating various components of the system including electronic open and close valve(s) 107 for the flow of wastewater influent fed into the at least one inlet 104 in the lower portion 106 thereof and for operating electronic open and close valve(s) 107 for flow of effluent through the at least one effluent outlet 116 or for removal of sludge through the at least one sludge outlet 152. The motor control system 158 may also be in operable communication with the controllers 156 of the at least one stirring mechanism 154 if desired. Features such as switchgear 182 may also be included in a given operation.

As shown in FIG. 14, illustrating process control system 172, an overview of a sample installation of apparatus 102 is shown having reactor vessels 124, 126 and 128 are arranged in communication fluidly through conduits 130, 132 as described above, but are in an L-configuration and not a straight line, which does not matter for operation, but provides a better use of space. The effluent leaving the AMBR in the embodiment shown through the at least one effluent outlet 116 is sent to an effluent buffer tank 160. Also shown are various heat exchangers 162 for heating or cooling influent or effluent in operation. Hot water heater burners 164 are provided along with hot water pumps 166 for use also in heating operations. Influent may be passed through an equalization tank 168 before entering the main feed pump 170, and then optional heating prior to introduction to the AMBR through inlet 104. The apparatus may also be installed near or using a gas upgrading and/or utilization area and a biogas storage area 174 for storing biogas produced from the AMBR.

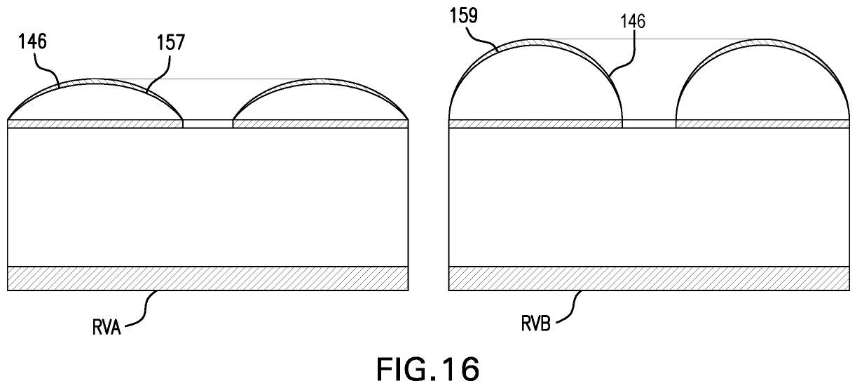

Biogas storage in one embodiment herein may be incorporated into use of a tank cover (instead of or in addition to a biogas storage area 174). Each of the reactor vessels may have an expandable cover that enlarges upon application of air pressure. Such covers are inflatable as shown, for example, in FIGS. 16-24 herein as inflatable cover 146 for collection and storage of biogas from the vessels. Such covers are known in the art and are commercially available such as from Membrane Systems, Europe, Evoqua Water Technologies, and others. The covers are typically made of a resilient polymeric membranes that are weather-resistant and sufficiently puncture-resistant for gas collection. They can be secured with belts and other fasteners to framework or structure within the reactor.

Such expandable membrane covers preferably are installed on a suitable framework 184 that may be supported within the reaction vessel preferably without obstructing the flow and circulation within the system. A variety of reactor cover heights may be used but a convex curved design with a central attachment, for example, as shown in a general representative form over a mixing mechanism, is useful herein, as shown with a an overall toroidal (doughnut-shaped) design in FIG. 16. The central mixing structure and mount may fit within the central portion of the toroid configuration and in longitudinal cross-section, as shown representatively in FIG. 16, wherein a reactor vessel RVA having a low toroidal profile and an reactor vessel RVB having a high toroidal profile are shown each with a dual convex balloon cover over the reactor vessel. Such designs may be varied in size and shape as well as membrane materials within the scope of this disclosure. It is also contemplated that gantries, walkways, other fasteners and modified frameworks can be used in such an embodiment for biogas storage.

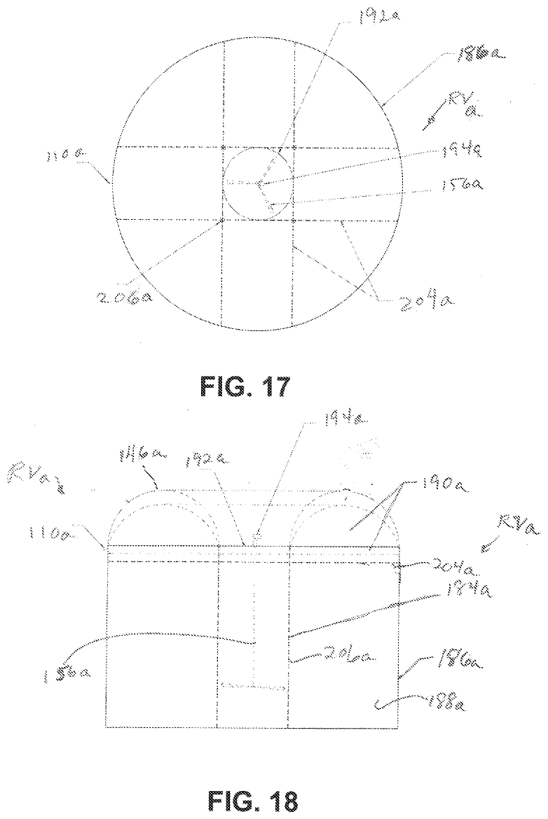

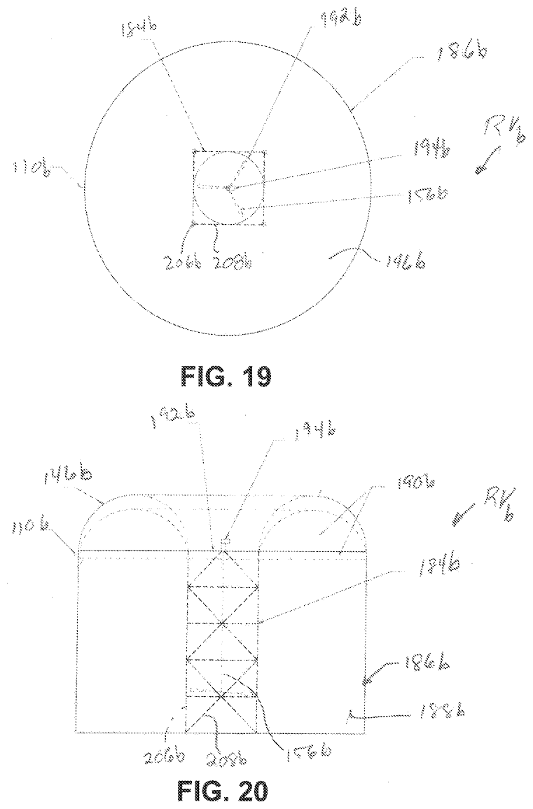

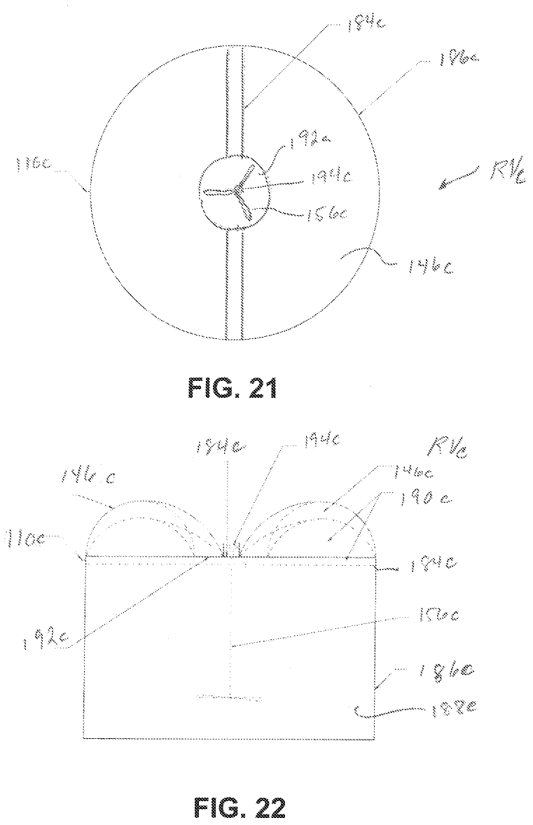

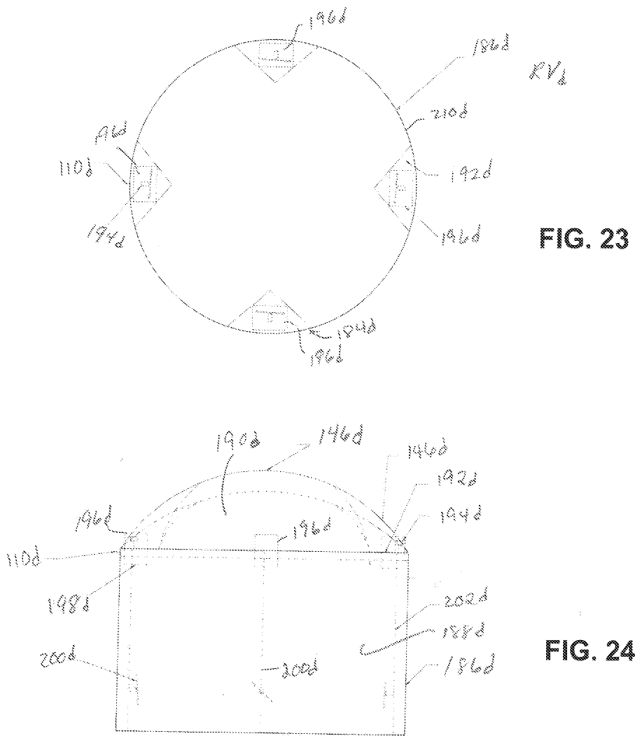

FIGS. 17-24 show varying examples of embodiments of AMBR reactor vessels RV which may be configured as described herein and as shown in the drawings with respect to reactor vessels 124, 126, 128. Each of the reactor vessels shown in the example embodiments in these Figures, RVa (FIGS. 17-18), RVb (FIGS. 19-20), RVc (FIGS. 21-22) and RVd (FIGS. 23-24), have similar tank-like structures designed for the AMBR process and configured as with other vessels to have an outer wall 186a, 186b, 186c, 186d and an inner reaction chamber suitable to carry out the reactions in the manner of AMBR chambers 118, 120, 122 herein. In FIGS. 17-24, the reaction chambers are shown as 188a, 188b, 188c and 188d. As shown the vessel walls and chambers are analogous in the FIGS. 17-24, but can be varied depending on the AMBR design chosen. In these Figures analogous reference numbers relate to analogous features that carry out similar or the same functions.

In each embodiment in FIGS. 17-24, an inflatable cover 146a, 146b, 146c and 146d is provided to the top of the reactor vessels RVa, RVb, RVc and RVd as shown also in representative FIG. 16. Depending on the support structure and cover design, varying covers may be chosen and shaped and connected to cooperate with outer support structures, walkways or mixing mount support structures. In FIGS. 16-24, the cover is a dual membrane biogas storage cover which inflates by positive air pressure generated by a fan. In the embodiment of FIGS. 17-18, an optional walkway (not shown) may be provided as to go up and over the cover for access to the central mixer. Stored biogas is in a biogas storage section 190a, 190b, 190c, 190d within the inflated cover. In FIGS. 17 and 18, the cover is toroidal and a work platform 192a, is situated in the center of the toroidal structure which can be accessed by usual methods such as an aerial catwalk or the like (not shown). In FIGS. 17 and 18, a mixer motor and gear box 194a are shown mounted to the platform 192a for operating a centrally mounted stifling mechanism 156a. A similar structure appears in FIGS. 19 and 20, a work platform 192b is positioned similarly to that of FIGS. 17 and 18, and a motor and gear box 194b are mounted thereon for operation of stifling mechanism 156b. Also, as with FIGS. 17-18, in the embodiment of FIGS. 19 and 20, an optional walkway (not shown) may be provided to go up and over the cover for access to the central mixer.

In FIGS. 21 and 22, a similar platform is present for mounting a gear box 194c and stirring mechanism 156c, which is positioned as a walkway support structure 184c toward a central work platform 192c on which are mounted the gear box and stirring mechanism. The toroidal structure forms around the central work area and walkway. In FIGS. 23 and 24, a work platform 192d supports the more dome-like inflatable cover 146d. This embodiment having a generally dome-like cover may incorporate horizontal mixers. The dome-like structure is “cut” in several areas where downwardly extending mixer access structure(s) 196d are positioned allowing a hatch 198d for mixer access that extends through the water surface. Within these structure(s) 196d, which may be positioned around the periphery 210d of the inflatable cover 146d and reactor vessel RVd, may be further mounted one or more mixer motor(s) and gear box(es) 194d. Each of the structures 196d also supports a horizontal mixer 200d. The stirring mechanism that appears as horizontal mixer(s) 200d, may be raised or lowered for servicing using a mast 202d. As shown in FIGS. 23 and 24, there are four such mixer access structures(s) 196d and platforms 192d, giving the top view of the inflatable cover 146d an X-like pattern, but the positioning and shape of such structures can be varied depending on the cover used and desired number of additional horizontal mixers to be employed.

In each of the Figures, when necessary or continuously stored biogas from the process may be removed through biogas outlets 110a, 110b, 110c, 110d.

Each vessel's support structure 184 may be varied if desired. Work platforms 192 may be considered part of an overall support structure as can any other support structure that helps maintain one or more stirring apparatus(es), or provides support for the inflatable covers, or support for other related mixers (as in FIGS. 23-24). FIGS. 17-18 show a support structure 184a having support beams 204a and optional support columns 206a. This can give extra strength to support the stirring mechanism and the inflatable cover, while also allowing for flow in and around the columns and beams.

FIGS. 19-20 show a similar design, however, instead of just support beams and central columns, the support structure 184b includes a free standing frame 208b. The frame and corner columns 206b within the frame 208b may be removed and replaced for maintenance purposes and help to support the stirring mechanism and the inflatable cover while also allow for flow through and around the support structure 184b.

In the embodiments of FIGS. 21-22 and 23-24, the support structures as shown in the embodiments of FIGS. 17-20 may be used or other optional support structures can be provided depending on the design of the tank and cover. These embodiments also feature other components of the prior embodiments such as the tank structure and any cross beam or lid structure, as well as any work platform and/or walkway. As shown in FIGS. 21-22 the central stirring mechanism 156c and the inflatable cover 146c may be supported as in the prior embodiments. The “cut-out” mixer access structures as in FIGS. 23-24 may support the stirring apparatuses 200d as shown and the embodiment may include horizontal mixers. The additional support structures in FIGS. 17-20 may be used optionally within FIGS. 21-24 as well.

In the embodiment of FIGS. 21-22, the structure incorporates a central walkway below the top of the cover, forming the cover into two halves. This cover embodiment may also be used with either of the mixer support structures of the embodiments of FIGS. 17-20.

The invention will now be further explained with respect to the following non-limiting example.

### EXAMPLE

A 0.51 m³ AMBR according to the improved invention design herein was built and ran for more than four months using a dairy farm manure-containing influent. Three reactor vessels were used as described herein set up for first stage, second stage and third stage reactions in a first direction and reversed flow in the opposite direction and using the steps wherein feed flows first to the first reactor vessel (first stage) and then through the second reactor vessel (second stage) to the third reactor vessel (third stage); then to the second stage through to the third stage; then the flow was reversed to feed to the third reactor vessel (now first stage), through the second reactor vessel (second stage) to the first reactor vessel (now third stage), and finally to the second reactor vessel (second stage) and then to the first reactor vessel (third stage). Such steps were ran continuously.

In evaluating the improved AMBR design for wastewater treatment, the applicant evaluated the original predecessor AMBR U.S. Pat. No. 5,885,460 which recommended the following feeding sequence and feed time periods in its text as shown in Table A below:

TABLE A

| Reactor Fed | Hours Fed |
|---|---|
| 1 | 6 |
| 2 | 2 |
| 3 | 6 |
| 2 | 2 |
| | Total 16 |

Further, Reactors 1 and 3 were each fed for 6 hours, so that each received 38% of the reactor loading share, whereas reactor 2 received only 4 hours of loading or 25% of the total reactor loading share. In the cycle of Table A, 75% of the time, feed was to reactors serving as stage 1 reactors, while only 25% of the time feed was directed to the second stage reactor. Based on the applicant's improved design, and that SCOD is easily degradable, it is readily seen that the system of the predecessor patent above was not being overloaded with a high level organic loading rate (OLR) and was removing primarily significant amounts of SCOD from in its wastewater.

Using the inventive AMBR apparatus and method herein, and the steps noted above, the AMBR structure and method were used on dairy manure having a high PCOD influent. As PCOD is digested first through the process of hydrolysis, which is slower than acidogenesis and methanogenesis (which are used to digest SCOD), the inventive AMBR and its method were designed to allow for more time in the hydrolysis stage. Feeding cycle and flow were adjusted using the improved AMBR design to heavily load stage two (in the example apparatus this is the second reactor vessel). The objective of the AMBR herein for treating high PCOD wastewater is to limit the PCOD load to stage 1 by feeding more to stage 2 so that the biodegradable fraction of the SCOD and PCOD in stage 1 can be completely converted before it becomes stage 3 when the flow is reversed. This minimizes the gas production in stage 3, so that it can function as an effective clarifier. The example achieved nearly complete conversion of the degradable PCOD fraction through increased solid retention time and optimizing hydrolysis. The AMBR design process aims to identify the SRT that is likely to achieve substantially complete conversion of the biodegradable fractions of SCOD and PCOD in the wastewater.

The following feeding total time listed below with reverse flow was used in the inventive Example herein as shown in Table 1:

TABLE 1

| Reactor Vessel | Hours Fed |
|---|---|
| 1 | 13 |
| 2 | 11 |
| 3 | 13 |
| 2 | 11 |
| | Total: 48 hours |

In a completed cycle, 54% of the time, feed was going to a stage one reactor (the first or the third reactor vessel depending on flow direction), while 46% of the time, feed was sent to the stage two reactor (second reactor vessel). The first stage reactor vessels received 27% of the total reactor loading share each, while the second stage reactor received 46% of the total reactor feed. Thus, the second stage was significantly highly loaded. This operation limited the load of PCOD in stage 1 so that it was able to more readily digest SCOD, while stage two reacted the bulk of the PCOD, such that by stage three in a cycle, the gas potential of the feedstock is exhausted, and the reactor functions more effectively in that stage as a clarifying reactor. The flow is then introduced into the third reactor so as to operate in reverse as a stage one vessel as noted in the steps described above.

During piloting, the HRT ranged from about two to about ten days. During the piloting phase that was focused on reaching the maximum conversion of PCOD in the manure when the manure was relatively dilute, the average HRT was about 3.6 days. This may be decreased in some operations through sludge concentration. However, when the PCOD load fraction becomes elevated, lower OLR and higher HRT will be needed to achieve the desired solids retention time (SRT) to convert the degradable fraction of PCOD in the flushed dairy manure.

The experimental system was stably operated at an OLR between 2.5 and 5.5 kg COD/m³/day. The upper limit of OLR was not determined in testing. For a typical California flushed dairy manure digester end application, an OLR of 2.5 kg COD/m³/day is conservatively feasible. The AMBR apparatus was operated at a temperature of 90° F. which kept the bacteria in the mesophilic range that worked well for PCOD degradation while avoiding thermophilic degradation.

The experimental AMBR included intermittent mixing from low-shear, high-flow axial mixers that allowed for good substrate and biological interaction and decreased probability of significant accumulation of inert solids in the apparatus from dead zones that may occur in the bottom of such reactor tanks. The mixing strategy was adjusted during testing to mix the stage three reactor vessels less frequently than the reactors handling stage one and two operations to allow for enhanced decanting of the digested supernatant and better retention of active sludge biomass.

In designing the improved AMBR, the applicant took into account that high PCOD influent streams are typically less biodegradable. Thus, their accumulation of indigestible and non-productive sludge solids in the reactor will increase, reducing available volume for active sludge solids (bioVSS solids). The applicant herein improved the apparatus and method so that it would be able to digest wastewater of varying levels of non-degradable solids and active sludge (bioVSS). Dairy manure and similar agricultural waste are unique in that they contribute active sludge (bioVSS) resulting in the need to grow less bioVSS in the apparatus, contributing to shorter SRT to fully degrade the feedstock. Thus, in optimizing the process, the bioVSS fraction of the sludge (its sludge quality) is determined by the fractions and biodegradability of the SCOD and the PCOD in the wastewater.

The selected SRT for the apparatus should exceed the minimum time needed for substantially complete conversion of the biodegradable PCOD in the substrate. The SRT should allow for degradation of most, if not all, of the biodegradable fraction of the PCOD. This will also result in the lowest sludge yield, and the highest sludge quality which leads to the smallest reactor size. This can be determined using biomethane potential (BMP) testing as is known in the art.

Total sludge yield is the VSS that were not degraded plus the bioVSS accumulation. The VSS not degraded is expressed less the PCOD bioVSS contribution. The bioVSS accumulation includes PCOD bioVSS plus bioVSS resulting from PCOD and SCOD conversion. Waste anaerobic sludge should equal the total sludge yield less what is lost in the effluent to keep the system in balance. If sludge is under-wasted, sludge inventory increases to the point that excessive sludge is in the effluent. If sludge is over wasted, the inventory of sludge decreases to the point where bioVSS TCOD substrate utilization rate (denoted as bioVSS TCOD SUR) and substrate hydrolyzation rate denoted as bioVSS PCOD SHR) are exceeded and the system is overloaded and may crash. The reactor size should thus be determined to allow the right amount of bioVSS in the system so that allowable bioVSS TCOD SUR and bioVSS PCOD SHR for the wastewater are not exceeded. Adequate volume facilitates the required SRT to maximize biodegradation so that biogas production is maximized and gross sludge yield (and reactor size) are minimized. The resulting system is in balance and intrinsically stable.

These goals are achieved in the improved AMBR apparatus and method as the increased loading to the second stage reactor(s) minimizes PCOD loading in a stage one reactor. The intermittent mixing and reversal of flow retain and redistribute solids in the system and concentrate the sludge to achieve required sludge inventory. The sludge is wasted consistent with the gross sludge yield at the target SRT to maintain a consistent sludge inventory and maintain the target SRT.

In validation testing of the experimental AMBR apparatus of the Example, sludge was removed automatically using automated valves and controls from near the bottom of the stage three reactor tank (reactor vessels one or three depending on the direction of flow). The sludge was removed during flow steps shown in FIGS. 2 and 4 where influent was directed to stage two. This resulted in the lowest probability of wasting undigested wastewater. The apparatus functioned by retaining and concentrating solids in the system.

Ultimately, the bioVSS fraction of sludge is determined by the composition and biodegradability of SCOD and PCOD fractions in the wastewater. The process and apparatus are thus controlled through testing of sludge concentrations, calculation of overall sludge inventory, and estimation of gross sludge yield. Then, calculation may be made to determine the required sludge wasting rate to achieve the target SRT. This may be automated using total solids meters monitoring inflows and outflows of solids and may be part of the control system herein, when such meters are sufficiently accurate, robust and reliable to be useful.

In evaluating flushed dairy manure the applicant validated a concentration of 1% mixed liquor volatile suspended solids (MLVSS). This is influenced by wastewater composition, the degree that the sludge settles, the height of the tanks and intermittent mixing schedule. The AMBR apparatus herein can increase the concentration of sludge in the system that will increase the system capacity and allow for smaller reactor sizes to accommodate the same organic loading. Thus, the system would achieve higher OLR with increased sludge concentration. Waste anaerobic sludge was observed at 1.8% MLVSS in the AMBR system testing. This shows the potential for increasing sludge concentration and overall sludge inventory.

As total volumetric flow rate changes seasonally (due to changes in dilution water), the COD concentration can also change inversely. For such waste streams, when total daily flow decreases, the system HRT can approach the target SRT. When influent flow allows an HRT above about 16 days, the AMBR apparatus herein can be transitioned to operate as a series of continuously stirred tank reactors (CSTRs). This is an added functionality that increases the range of potentially treatable waste streams without the need for additional infrastructure change. Flow can also be periodically reversed to avoid overloading conditions in stage one reactors and redistribute or distribute SCOD and PCOD converting microorganisms or sludge in each of the reactors. Flow reversal will still add the additional feast-famine mode to the AMBR apparatus and method periodically causing a shortage of SCOD and promoting the digestion of PCOD. The feast-famine mode is provided to the AMBR apparatus and method by periodically causing a shortage of SCOD and promoting the digestion of PCOD. This will help both SCOD and PCOD degradation occur in the reactor vessels. When operating the apparatus herein in a CSTR-type mode, sludge wasting is not indicated.

The apparatus and method herein through testing may be employed in a wide range of potential wastewater and industries. The apparatus and method are robust and stable when operated at an OLR of about 2.5 to about 5.5 kg/m³/day on flushed dairy manure, and have the potential for stable digestion at even higher OLRs, at greater biodegradability of the PCOD fraction or with increased reactor sludge concentrations. The achievable OLR is largely determined by the PCOD/TCOD ratio of the feedstock as well as the biodegradability of the PCOD and SCOD fractions.

The greater the PCOD fraction and the lower the biodegradability of the PCOD fraction, the greater the accumulation of non-degradable PCOD in the sludge (contributing to lower sludge quality) and the greater the resulting gross sludge yield. In such cases, a lower OLR is needed to achieve the minimum 17-20 day SRT required for substantially complete conversion of the biodegradable fraction of the PCOD in the feed. The AMBR apparatus and method herein can efficiently digest dilute waste streams without falling into the typical pitfalls of HRT and solids limitations encountered by competing anaerobic digestion systems. The AMBR apparatus and method herein can process influents with varying characteristics. Testing showed that essentially all the degradable SCOD and nearly all of the degradable PCOD can be digested with the proper system sizing and management.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of treating wastewater comprising soluble chemical oxygen demand and particulate chemical oxygen demand, comprising
(a) providing an anaerobic migrating blanket reactor apparatus having a structure that has at least one inlet for wastewater influent in a lower portion thereof, at least one biogas outlet in an upper portion thereof, at least one sludge drain, and at least one outlet for removal of effluent, wherein the structure of the anaerobic migrating blanket reactor defines at least three reaction chambers comprising a first reaction chamber, a second reaction chamber and a third reaction chamber, and wherein the at least three reaction chambers are configured to permit bidirectional, generally transverse flow, in a first direction and a second direction, through the at least three reaction chambers;
(b) introducing wastewater influent into the at least one inlet so as to enter the first reactor chamber of the anaerobic migrating blanket reactor and flowing the wastewater in a first direction through the first reactor chamber, the second reactor chamber, the third reactor chamber and through the at least one an effluent outlet for a first period of time;
(c) introducing the wastewater influent into the at least one inlet so as to enter the second reactor chamber of the anaerobic migrating blanket reactor and flowing the wastewater in the first direction through the second reactor, the third reactor and through the at least one effluent outlet for a second period of time;
(d) introducing the wastewater influent into the at least one inlet so as to enter the third reactor chamber of the anaerobic migrating blanket reactor and flowing the wastewater in a second direction through the third reactor chamber, the second reactor chamber, the first reactor chamber and the at least one effluent outlet for a third period of time; and
(e) introducing the wastewater influent into the at least one inlet so as to enter the second reactor chamber and flowing the wastewater in the second direction through the second reactor, the first reactor and the effluent outlet for a fourth period of time,
wherein a mass load of the particulate chemical oxygen demand to the second reactor chamber (i) in the first direction of flow during the first and the second periods of time while the third reactor chamber acts as a clarifying chamber, and (ii) in the second direction of flow while the first reactor chamber acts as a clarifying chamber during the third and the fourth periods of time, allows for substantially complete digestion of biodegradable loads of the particulate chemical oxygen demand and the soluble chemical oxygen demand.

2. The method according to claim 1, wherein a mass load of the particulate chemical oxygen demand to the first reactor chamber during the first period of time in the first direction of flow is limited such that the particulate chemical oxygen demand and the soluble chemical oxygen demand is converted and biogas production minimized before the first reactor chamber becomes a clarifying chamber upon initiation of the third period of time and reversal of flow to the second direction.

3. The method according to claim 1, wherein after step (e), steps (b) through (e) are repeated at least once, and wherein a mass load of the particulate chemical oxygen demand to the third reactor during the third period of time in the second direction of flow is limited such that the particulate chemical oxygen demand and the soluble chemical oxygen demand is converted and biogas production minimized before the third reactor chamber becomes a clarifying chamber upon initiation of the first period of time and reversal of flow to the first direction in the repeated step (b).

4. The method according to claim 1, wherein the sum of the second period of time and the fourth period of time is greater than either the first period of time or the third period of time.

5. The method according to claim 1, wherein the wastewater influent has a particulate chemical oxygen demand content of at least about 15 percent of a total chemical oxygen demand.

6. The method according to claim 5, wherein the wastewater influent has a variable particulate chemical oxygen demand content.

7. The method according to claim 1, wherein wastewater influent comprises flushed dairy manure.

8. The method according to claim 7, further comprising using an organic loading rate of about 2.5 kg COD/m³/day to about 5.5 kg COD/m³/day.

9. The method according to claim 1, wherein the anaerobic migrating blanket reactor structure has at least a first reactor vessel including the first reactor chamber, a second reactor vessel including the second reactor chamber and a third reactor vessel comprising the third reactor chamber.

10. The method according to claim 9, wherein each of the first reactor vessel and the third reactor vessel are in fluid communication with the second reactor vessel and the method further comprises providing bidirectional, generally transverse flow through the first, the second and the third reactor vessels.

11. The method according to claim 10, wherein a first conduit is provided extending from the first reactor vessel to the second reactor vessel and a second conduit is provided extending from the second reactor vessel to the third reactor and the method further comprises providing bidirectional, generally transverse flow through the first and the second conduits.

12. The method according to claim 11, wherein the anaerobic migrating blanket reactor structure further comprises generally longitudinally extending members for directing flow, the members positioned within the first, second and third reactor vessels near the ends of the first and the second conduits, and the method further comprises directing biogas upward and sludge downward within the reactor vessels guided at least in part by the generally longitudinally extending members.

13. The method according to claim 11, wherein the first conduit and the second conduit are positioned such that at least a first end of the first conduit and a first end of the second conduit is respectively vertically positioned between a middle of and a top of the first reactor vessel and a middle of and a top of the second reactor vessel.

14. The method according to claim 13, wherein the first conduit and the second conduit extend horizontally.

15. The method according to claim 13, wherein a second end of the first conduit and a second end of the second conduit are each respectively positioned vertically near a bottom of the second reactor vessel and near a bottom of the third reactor vessel.

16. The method according to claim 15, wherein the anaerobic migrating blanket reactor further comprises a third conduit extending between the first reactor vessel and the second reactor vessel and a fourth conduit extending between the second reactor vessel and the third reactor vessel and a first end of the third conduit and a first end of the fourth conduit are each respectively vertically positioned near a bottom of the first reactor vessel and near a bottom of the second reactor vessel, and a second end of the third conduit and a second end of the fourth conduit are respectively vertically positioned between a middle of and a top of the second reactor vessel and a middle and a top of the third reactor vessel.

17. The method according to claim 14, wherein the anaerobic migrating blanket reactor further comprises a third conduit extending between the first reactor vessel and the second reactor vessel and a fourth conduit extending between the second reactor vessel and the third reactor vessel.

18. The method according to claim 17, wherein a first end of the third conduit and a first end of the fourth conduit are respectively vertically positioned near a bottom of the first reactor vessel and a bottom of the second reactor vessel and the third conduit and the fourth conduit extend horizontally.

19. The method according to claim 1, wherein the anaerobic migrating blanket reactor further comprises a conduit extending between the first reactor vessel and the third reactor vessel and one of the at least one effluent outlet is positioned on the second reactor vessel.

20. The method according to claim 1, wherein the anerobic migrating blanket reactor structure is a single reactor vessel having walls therein to isolate within the vessel at least the first reactor chamber, the second reactor chamber and the third reactor chamber.

21. The method according to claim 1, wherein the at least one outlet for removal of effluent in the anaerobic migrating blanket reactor apparatus comprises an opening in the structure of the apparatus in fluid communication with outlet pipe, and the method further comprises providing a baffle positioned around the outlet opening within the apparatus, directing effluent toward the outlet opening, and providing a diverter positioned to divert biogas around the baffle.

22. The method according to claim 1, wherein the anaerobic migrating blanket reactor further comprises a stirring mechanism within each of the first reactor chamber, the second reactor chamber and the third reactor chamber, and the method further comprises stirring the fluid and sludge within each of the first reactor chamber, the second reactor chamber and/or the third reactor chamber continuously or intermittently.

23. The method according to claim 22, wherein the stirring mechanism is an axial mixer.

24. The method according to claim 23, wherein the stirring mechanism is a low-shear, high-flow axial mixer.

25. The method according to claim 22, further comprising operating the stirring mechanism in the first reactor chamber or the third reactor chamber, when the first reactor chamber or the third reactor chamber is acting as the clarifying chamber, less frequently than the stirring mechanism in either of the remaining reactor chambers.

26. The method according to claim 1, further comprising repeating steps (b) and (c) and/or steps (d) and (e) at least once.

27. The method according to claim 1, wherein about 75 percent to greater than 25 percent of total wastewater influent particulate chemical oxygen demand mass load is introduced in the second stage during the second and fourth periods of time.

28. The method according to claim 27, wherein about 60 percent to about 40 percent of the total wastewater influent particulate chemical oxygen demand mass load is introduced in the second stage during the second and fourth periods of time.

29. The method according to claim 28, wherein about 50 percent to about 40 percent of the total wastewater influent particulate chemical oxygen mass demand load is introduced in the second stage during the second and fourth periods of time.

30. The method according to claim 27, wherein a total wastewater influent feed time is the total time of the first, second, third and fourth periods of time, and a total of the second and the fourth periods of time is about 75 percent to greater than about 25 percent of total wastewater influent feed time.

31. The method according to claim 30, wherein the total of the second and the fourth periods of time is about 60 percent to about 40 percent of the total wastewater influent feed time.

32. The method according to claim 31, wherein the total of the second and the fourth periods of time is about 50 percent to about 40 percent of the total wastewater influent feed time.

33. The method according to claim 27, wherein a loading volume of wastewater influent to the second reactor chamber is about 75 percent to about 25 percent of a total loading volume of the wastewater influent.

34. The method according to claim 33, wherein the loading volume of the wastewater influent to the second reactor chamber is about 60 percent to about 40 percent of the total loading volume of the wastewater influent.

35. The method according to claim 34, wherein the loading volume of the wastewater influent to the second reactor chamber is about 50 percent to about 40 percent of the total loading volume of the wastewater influent.

36. The method according to claim 1, further comprising increasing a percentage of total wastewater influent feed time to the second reactor chamber as a level of particulate chemical oxygen demand in the wastewater influent increases.

37. The method according to claim 1, further comprising at least substantially digesting the soluble chemical oxygen demand in the wastewater influent in the first reactor chamber and/or the third reactor chamber.

38. The method according to claim 1, further comprising at least substantially digesting the particulate chemical oxygen demand in the wastewater influent in the second reactor chamber.

39. The method according to claim 1, further comprising redistributing sludge through the first reactor chamber, the second reactor chamber and the third reactor chamber using the bidirectional flow to avoid accumulation of sludge in the first reactor chamber or the third reactor chamber when the first reactor chamber or the third reactor chamber is acting as the clarifying chamber.

40. The method according to claim 1, further comprising operating the anaerobic migrating blanket reactor at a temperature of about 80° F. to about 100° F.

41. The method according to claim 1, wherein in the first direction of flow, the first reactor chamber and the third reactor chamber are a first stage reactor and a third stage reactor respectively and the second reactor chamber is a second stage reactor for substantial digestion of the particulate chemical oxygen demand, and the method further comprises providing one or more additional second stage reactor chambers positioned between the first reactor chamber and the third reactor chamber.

42. The method according to claim 1, wherein in the second direction of flow, the first reactor chamber and the third reactor chamber are a third stage reactor and a first stage reactor respectively and the second reactor chamber is a second stage reactor for substantial digestion of the particulate chemical oxygen demand, and the method further comprises providing one or more additional second stage reactor chambers positioned between the first reactor chamber and the third reactor chamber.

43. The method according to claim 1, further comprising:
evaluating the wastewater influent to determine:
a proportion of particulate chemical oxygen demand and a proportion of soluble chemical oxygen demand in a total chemical oxygen demand, and
a gross sludge yield.

44. The method according to claim 43, further comprising periodic removal of waste sludge in a controlled manner.

45-67. (canceled)
